(19) United States
(12) Patent Application Publication
(10) Pub. No.: US 2007/0090179 A1
(43) Pub. Date: Apr. 26, 2007

(54) Procurance data management system

(76) Inventors: Fumio Konishi, Osaka (JP); Naoko Ichimaru, Nara (JP); Miwa Morita, Hyogo (JP); Yoshinori Honma, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/607,006

(22) Filed: Dec. 1, 2006

Related U.S. Application Data
(63) Continuation-in-part of application No. PCT/JP05/10228, filed on Jun. 3, 2005.

(30) Foreign Application Priority Data
Jun. 3, 2004 (JP) 2004-166460

(51) Int. Cl. G06F 17/00; G06K 15/00

(52) U.S. Cl. 235/375; 235/383

(57) ABSTRACT

A procurement data management system to judge environmental suitability of portions in design stages and product recycling. In this system, data of purchased items used in products, parts, and materials or chemical substances of purchased items are registered. A purchased item database manages registered data in a hierarchical relationship of purchased items, component parts of each purchased item, component materials of each part, and contained chemical substances of each material. An environmental standard database manages environmental standard data for chemical substances. The system utilizes the hierarchical relationship among purchased items between chemical substances to extract parts unsuitable for environmental standards among the parts in each product.

### RELATED APPLICATIONS

This is a Continuation-In-Part application of International Application PCT/JP2005/010228, filed Jun. 3, 2005.

This application claims convention priority from Japanese patent application 2004-166460, filed Jun. 3, 2004 which is hereby incorporated by reference.

### FIELD OF THE INVENTION

The present invention relates to a procurement data management system for managing chemical substances contained in purchased items used in products.

### BACKGROUND OF THE INVENTION

As the importance of social efforts on the environment is increasing, manufacturers of electric/electronic products are also required to provide products of low environmental burden and little influence on the human body, and the manufacturers set their own standards for chemical substances contained in their products. Also, restrictions on contained chemical substances are legally reinforced worldwide. For example, the RoHS (Restriction of certain Hazardous Substances in electrical and electronic equipment) enforced in Europe in July 2006 prohibits in principle the use of specific chemical substances such as lead, mercury, and cadmium in electric/electronic products.

In order to provide the market with environmentally-friendly products according to environmental standards such as regulations and one's own standards, manufacturers perform green procurement and/or product designs with due consideration to the environment. For managing contained chemical substances of many products in various stages such as procurement and design, it is effective to utilize a computer system.

Described in Japanese Unexamined Patent Application Publication No. 2001-56708 is a green procurement device for environmentally evaluating procurement sources of parts and materials which constitute each product. Searching is accomplished in the master database based on product, part, raw material, and substance to evaluate the degrees of environmental suitability of the products, parts, raw materials, and substances, and a list is displayed of the green product delivery rate by procurement sources on parts and materials of the same function.

Also, described in Japanese Unexamined Patent Application Publication No. 2001-38340 is a device which reduces the designer's burden for environmental evaluation in the product designing stage, and has a product proprietary information database which contains information on the item name, part proprietary code, material name, and contains chemical substances for each part constituting a design-finished product. In designing a new product, information on parts common with already designed products can be obtained from the product proprietary information database, and a parts list for the new product can be created. By using the information of an environmental burden information database in combination with the parts list, and parts having a large environmental burden among the parts used in the new product are discriminated and displayed. For example, if lead which is a harmful substance is contained in a component chemical substance of a printed circuit board used in the new product, the printed circuit board is displayed in a different color from other parts.

Even if a product is suitable for the regulations and environmental standards prior to its release to the market, if the lifetime of the product is long, after the release of the product to the market, restrictions may be enforced on chemical substances not restricted before the market release. In such a case, if the product is recycled or reused, a substance becoming subject to restriction must be removed from the product. As in devices described in Japanese Unexamined Patent Application Publication No. 2001-56708 and Japanese Unexamined Patent Application Publication No. 2001-38340, if chemical substances are managed for parts constituting products, it is difficult to specify how the chemical substances are utilized in the parts. Therefore, even if there are portions in a part which do not contain the restricted chemical substance, the whole part will be discarded. For example, if a final product manufacturer procures a parts-mounted printed circuit board from a parts manufacturer, even if there is a reusable part on the printed circuit board, it cannot be easily identified from the product data.

Also, in the design stage, it is difficult to judge whether only some modifications need to be made on product parts, completely different parts need to be used, or other design changes are required in order to make the product more suitable to the environment.

If the environmental burden data of purchased items procured as parts of each product is managed in units of purchased items, environmental evaluation of each product will end up being performed in units of parts not only in the stage of procuring materials but also in the stages of design, manufacturing, distribution, recycling, etc.

A system to thus manage data in units of parts of purchased items used in each product is desired.

### SUMMARY OF THE INVENTION

According to one aspect of the present invention, provided is a system for managing data related to purchased items used in products. The system comprises a data processor, a data storage device, and a data communication device. The data storage device has a purchased item database configured to manage the data of purchased items in the hierarchical relationship of each purchased item, component parts of each purchased item, component materials of each part, and chemical substances contained in each material; a list of purchased items used in each product; and an environmental standard database configured to manage data of the environmental standards on the chemical substances, and bears instructions executed by the processor to cause the system perform the steps of: when the data of the purchased item, and parts, materials, and chemical substances of the purchased item is received by the data communication device from a terminal of the procurement source of the purchased item, registering the received data to the purchased item database; retrieving the purchased items used in a specified product from the list; retrieving the data of chemical substances contained in the retrieved purchased items from the purchased item database; retrieving the environmental standards data for the retrieved chemical substances from the environmental standard database; judging whether the chemical substances contained in the product are suitable for the environmental standards by comparing the amounts of the chemical substances contained in the product obtained from the retrieved chemical substance data and the tolerated amounts obtained from the environmental standard data for the chemical substances; and responsive to the chemical substance being unsuitable for the environmental standards, extracting data of parts containing the unsuitable chemical substance among parts of purchased items used in the product are extracted from the purchased item database.

The data storage device can further have a procurement source group database configured to store data of procurement sources, a group to which the procurement sources belong, and data indicating whether the procurement source manages data related to the purchased items, in the group, and can further bear instructions executed by the processor to cause the system perform the steps of: deciding a specified procurement source should be the destination of a message requesting registration of the data related to the purchased items; if the specified procurement source is stored in the procurement source group database, searching the procurement source group database to decide a managing procurement source which manages the data related to the purchased items, in the group to which the specified procurement source belongs; deciding the managing procurement source should be the destination of a message requesting transfer of the data related to the purchased items; and responsive to the registration of the data related to the purchased items from the requested procurement source, if the requested procurement source is stored in the procurement source group database, granting a permission to the procurement source for utilizing data of the purchased item from the managing procurement source for the registration for the registration request message.

According to another aspect of the present invention, provided is a method for controlling a system for managing data related to purchased items used in products. The method comprising the computer-implemented steps of: when the data of a purchased item, and parts, materials, and chemical substances of the purchased item is received by the data communication device from a terminal of the procurement source of the purchased item, registering the received data to the purchased item database; retrieving the purchased items used in a specified product from the list; retrieving the data of chemical substances contained in the retrieved purchased items from the purchased item database; retrieving the environmental standards data for the retrieved chemical substances from the environmental standard database; judging whether the chemical substances contained in the product are suitable for the environmental standards by comparing the amounts of the chemical substances contained in the product obtained from the retrieved chemical substance data and the tolerated amounts obtained from the environmental standard data for the chemical substances; and responsive to the chemical substance being unsuitable for the environmental standards, extracting data of parts containing the unsuitable chemical substance among parts of purchased items used in the product from the purchased item database.

According to yet another aspect of the present invention, provided is a computer-readable medium containing instructions to control a system for managing data related to purchased items used in products. The computer-readable medium bearing instructions to control the system to perform the computer-implemented steps of: when the data of the purchased item, and parts, materials, and chemical substances of the purchased item is received by the data communication device from a terminal of the procurement source of the purchased item, registering the received data to the purchased item database; retrieving the purchased items used in a specified product from the list; retrieving the data of chemical substances contained in the retrieved purchased items from the purchased item database; retrieving the environmental standards data for the retrieved chemical substances from the environmental standard database; judging whether chemical substances contained in the product are suitable for the environmental standards by comparing the amounts of the chemical substances contained in the product obtained from the retrieved chemical substance data and the tolerated amounts obtained from the environmental standard data for the chemical substances; and responsive to a chemical substance being unsuitable for the environmental standards, extracting data of parts containing the unsuitable chemical substance among parts of purchased items used in the product from the purchased item database.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows the hardware construction of the procurement data management system in an embodiment of the present invention.

FIG. 2 is a block diagram showing the functional construction of the procurement data management system in an embodiment of the present invention.

FIG. 3 shows an example of web page for registering data of a purchased item.

FIG. 4 shows an example of web page for checking and registering the constitution of a purchased item.

FIG. 5 is a figure for explaining the constitution of a condenser which is an example of purchased items.

FIG. 6 is another figure for explaining the constitution of a condenser.

FIG. 7 shows an example of web page for registering data of a component part.

FIG. 8 shows another state of web site for checking and registering the constitution of a purchased item.

FIG. 9 shows an example of web page for registering data of a component material.

FIG. 10 shows yet another state of web page for checking and registering the constitution of a purchased item.

FIG. 11 shows an example of web page for registering data of a contained chemical substance.

FIG. 12 is a figure for explaining the hierarchical relationship of a purchased item, parts constituting the purchased item, materials constituting each part, and chemical substances contained in each material.

FIG. 13 shows an example of web page for checking contained chemical substance groups.

FIG. 14 is a figure for explaining dummy data.

FIG. 15 is a figure for explaining another hardware construction example of the procurement data management system.

FIG. 16 shows another functional construction example of the procurement data management system.

FIG. 17 shows an example of the constitution of the investigation request database.

FIG. 18 shows an example of the constitution of the procurement source database.

FIG. 19 shows an example of the main text of an investigation request mail.

FIG. 20 shows an example of web page for searching for an investigation request.

FIG. 21 shows an example of web page containing a list of target items of an investigation request.

FIG. 22 shows an example of the constitution of the model number database.

FIG. 23 shows another example of web page for registering data of a purchased item.

FIG. 24 is a figure for explaining the constitution of the purchased item database.

FIG. 25 shows an example of the constitution of the registered parts database.

FIG. 26 is a figure briefly showing the trade relationship among global corporations.

FIG. 27 shows a hardware construction of a computer used for the procurement management system.

FIG. 28 shows an example of the constitution of the procurement source group database.

FIG. 29 is a flow chart for explaining an example of the procedure for data registration process in the procurement management system.

FIG. 30 shows yet another example of web page for registering data of a purchased item.

FIG. 31 shows an example of data constitution of the material management database.

FIG. 32 shows another example of web page for registering data of a component material.

### DETAILED DESCRIPTION OF THE INVENTION

An embodiment of the present invention is explained hereafter with reference to the attached drawings. In this embodiment, the present invention is embodied as a procurement data management system for the manufacturer of a product to manage data of chemical substances provided by the suppliers of purchased items used in that product.

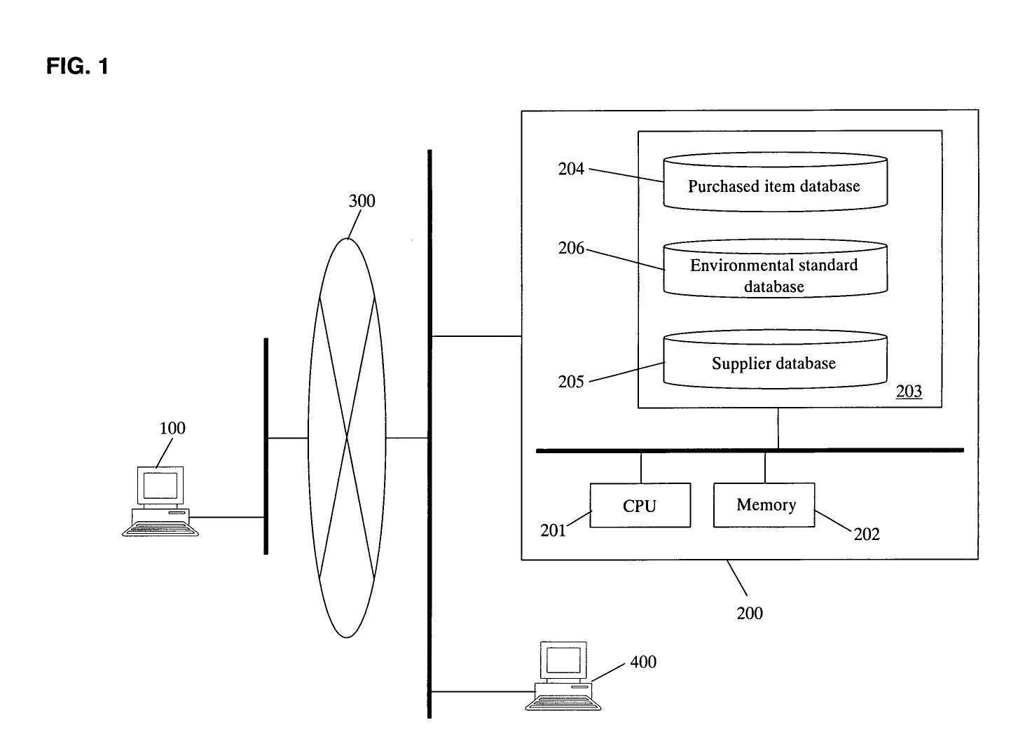

FIG. 1 shows the hardware construction of the procurement data management system in the embodiment. In the procurement data management system, a terminal 100 used by a supplier is connected with an application server 200 of the product manufacturer via a network 300.

As the application server 200, a general-use computer having a CPU (Central Processing Unit) 201, a memory 202, etc. can be utilized. The CPU 201 reads out a part or the whole of an application program onto the memory 202 such as RAM (Random Access Memory) and executes information processing according to the program instructions.

In this embodiment, data provided by the supplier are accumulated in an HDD (Hard Disk Drive) 203 of the server 200. If a web-based reception of data from the supplier is performed, the application program includes a web server. The web server program on the server 200 sends a web page which becomes an interface screen in response to requests from a web client on the terminal 100, and hands over arguments and data received from the web client to other programs. The pages sent from the web server program to the web client include pages generated dynamically by other programs based on the arguments and data received from the web client.

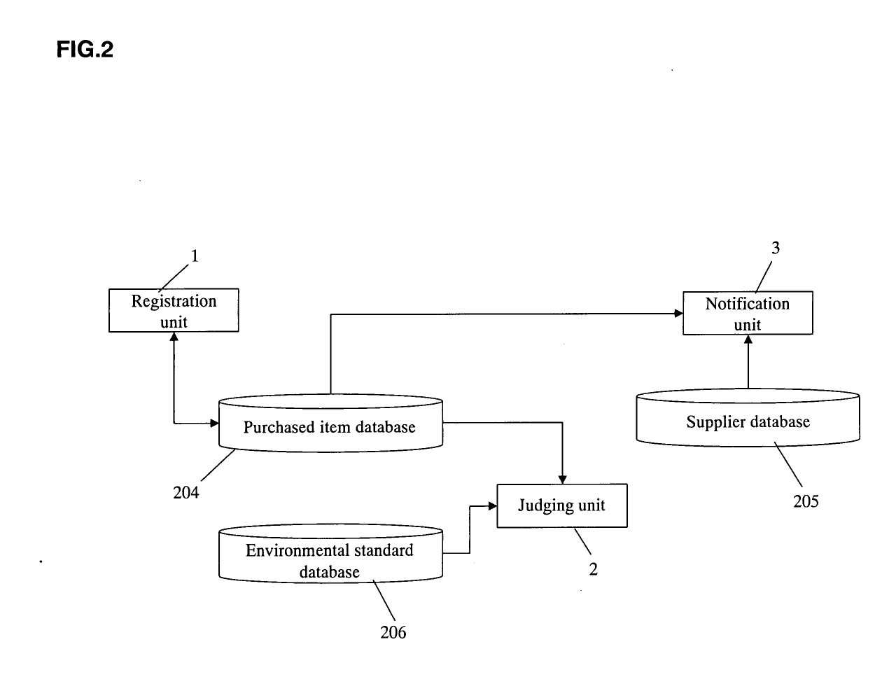

In a program which thus cooperates with a web server program, a procurement data management program is included for realizing the functions of the procurement data management system of the present invention on a computer. FIG. 2 is a block diagram for explaining the functions of a procurement data management system in this embodiment. This computer system functions as the procurement data management system of the present invention, by the procurement data management program realizing the functions of a registration unit 1, a purchased item database 204, an environmental standard database 206, and a judging unit 2.

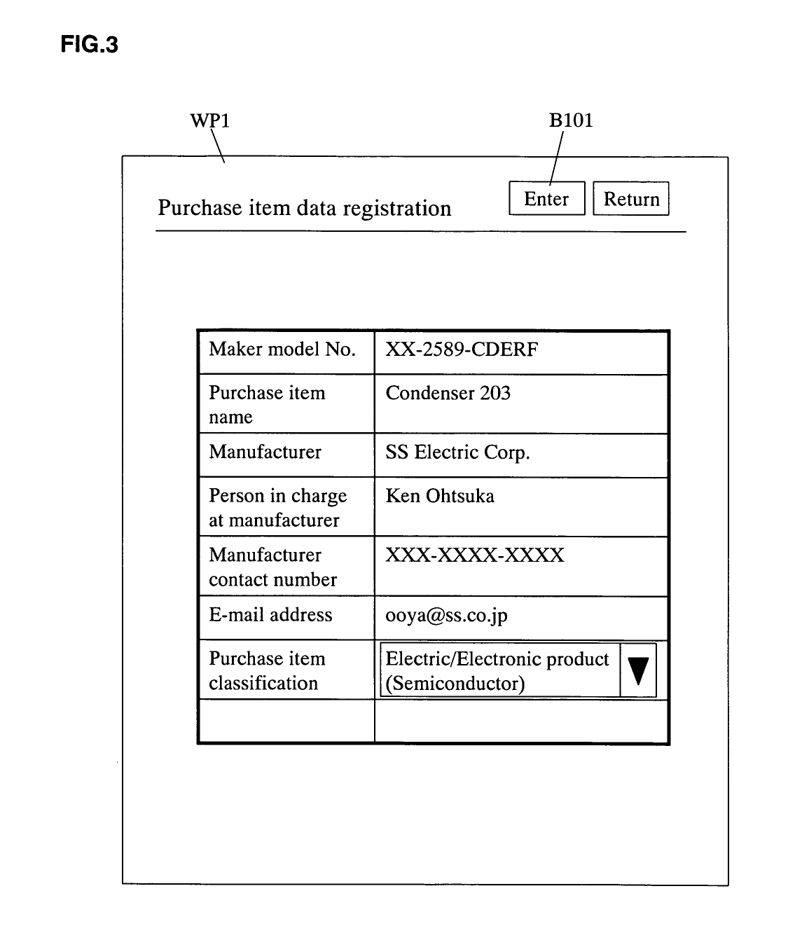

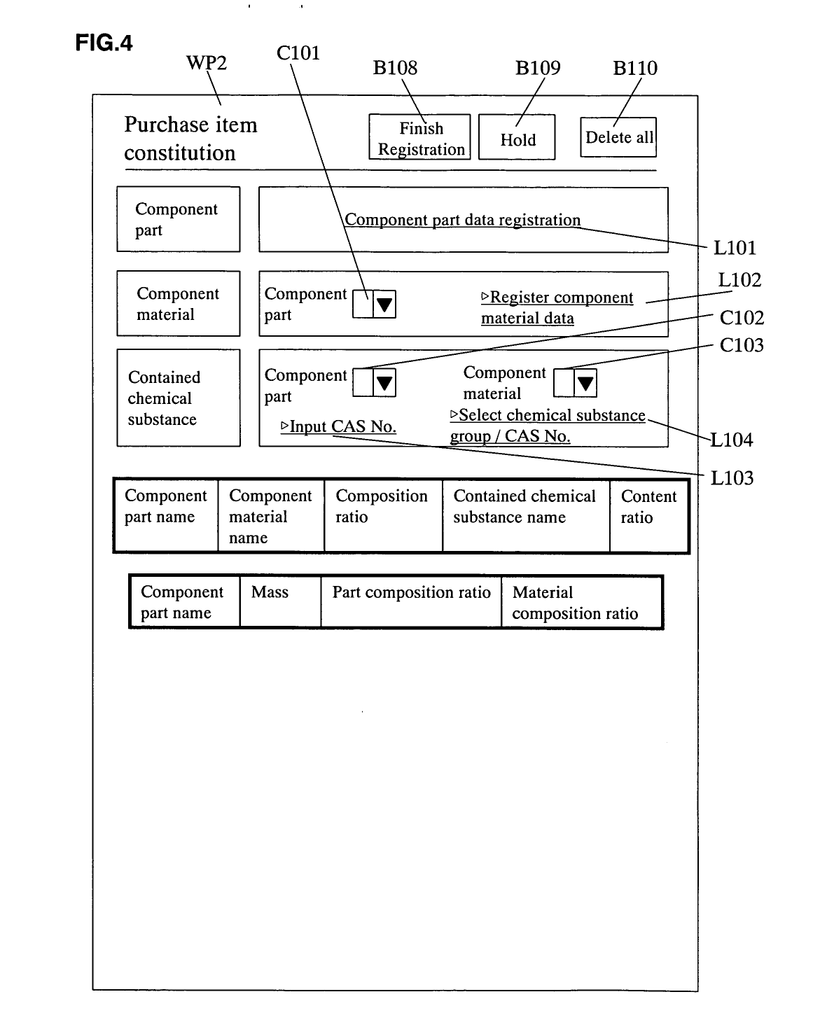

Each supplier user registers data of purchased items used in a product, and parts, materials, and chemical substances of each purchased item by the registration unit 1. In order to register data of each purchased item, the CPU 201 of the computer executes processing to send a web page WP1 as shown in FIG. 3 to a web client on the terminal 100. On this web page WP1, input fields are established for inputting data such as a purchased item name, the supplier contact, and the contact address. Once data are input in the input fields and a button B101 is pressed with an input means such as a mouse at the terminal 100, input data and a web page send request are sent from the terminal 100 to the server 200. When the data and request are sent, the CPU 201 sends a web page WP2 as shown in FIG. 4 to the terminal 100. On this web page WP2, a user interface is established for inputting component parts of the purchased item, component materials of each part, and contained chemical substances of each material.

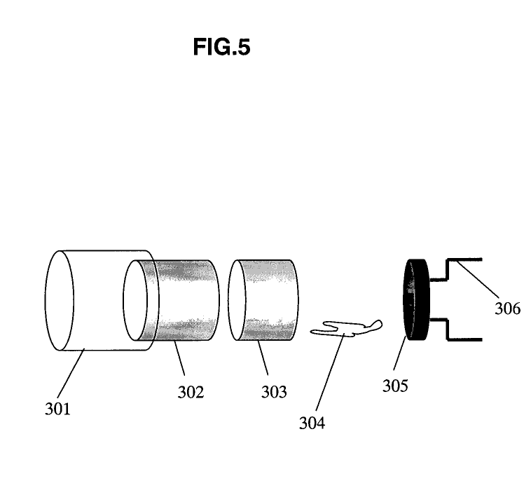

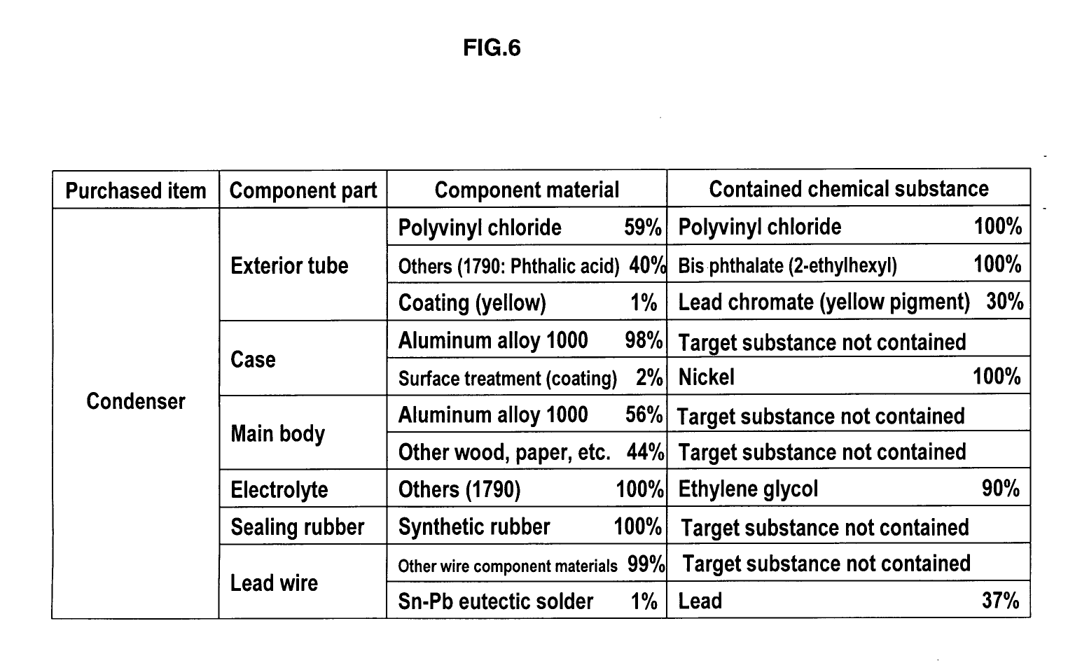

If the purchased item is a condenser, as shown in FIGS. 5 and 6, the condenser comprises external tube 301 and case 302, a main body 303, an electrolyte 304, a sealing rubber 305, and a lead wire 306. These component parts 301-306 are each composed of one or more materials. If it is a yellow external tube, that tube is composed of polyvinyl chloride 59%, yellow paint 1% and phthalic acid 40%. Each material contains one or more chemical substances. The paint contains lead chromate by 30% as yellow pigment.

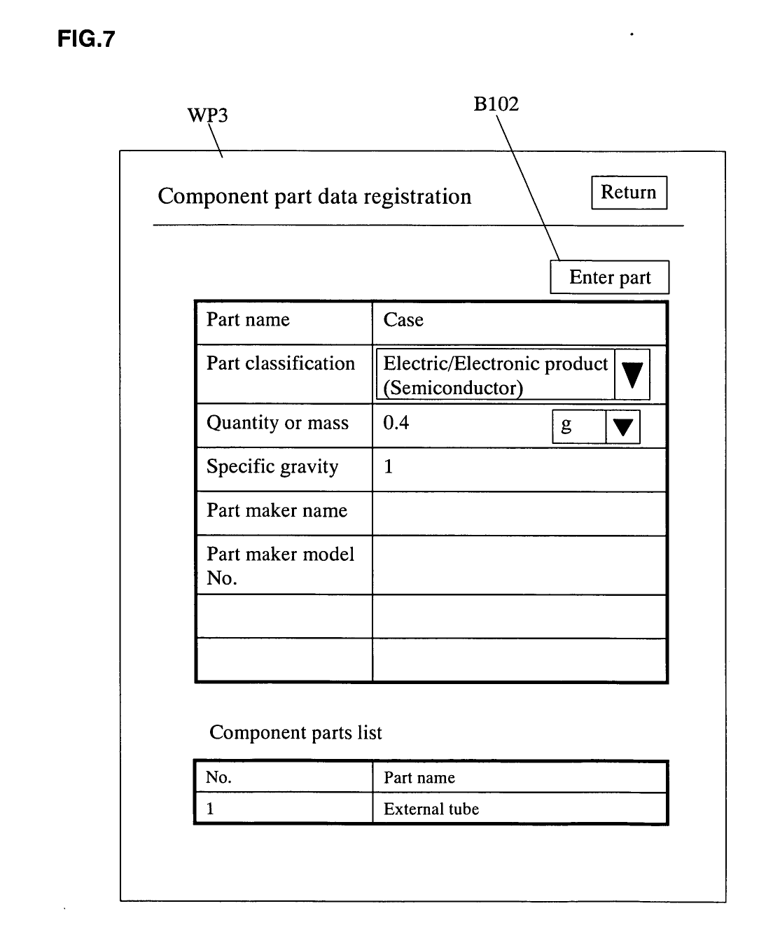

Each supplier user inputs data of such component parts, component materials of each part, and contained substances of each material. When a link L101 on the web page WP2 is selected, the CPU 201 sends a web page WP3 as shown in FIG. 7 to a web client on the terminal 100. That web page WP3 is for registering data of component parts. On web page WP3, fields are established for inputting a part name and the class of the part, the quantity or mass of the part, manufacturer name, manufacturer model number, etc. Once data are input in the input fields and a part input button B102 is pressed, input data and a web page send request are sent from the terminal 100 to the server 200. In this example, input are data of a case among the component parts of a condenser. Input and transmission of data of component parts are repeated by the number of the component parts.

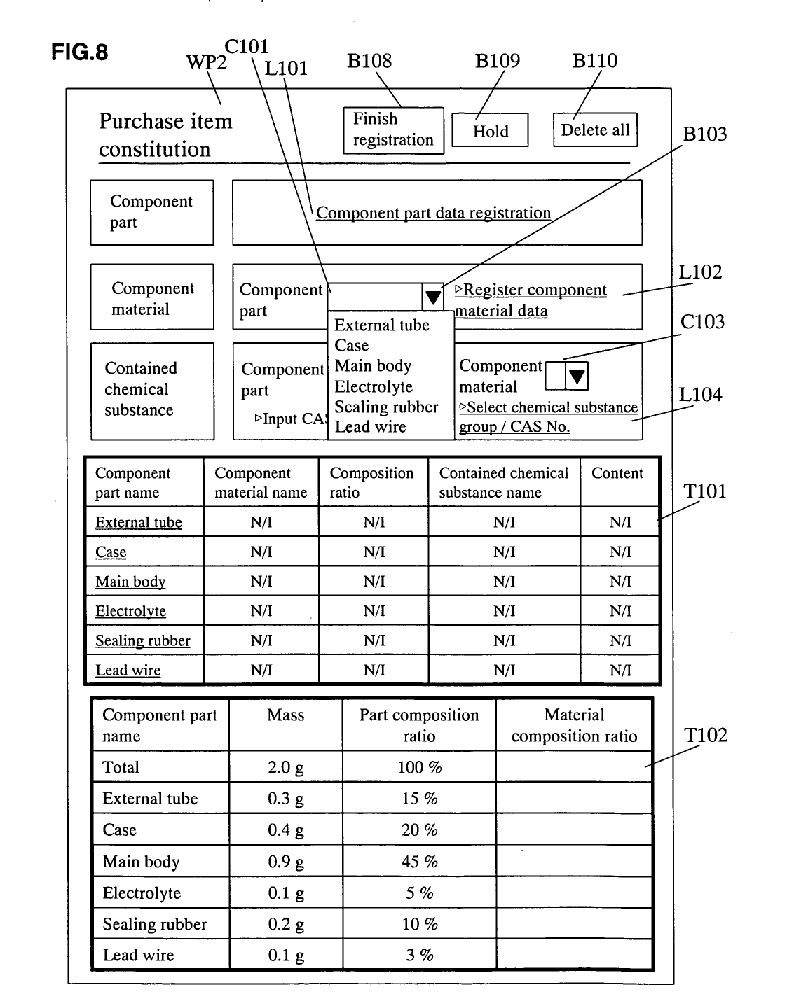

When data are received for all the component parts, the CPU 201 sends the web page WP2 to the terminal 100 again. At this time, the part name of the already-input component part is put in a combo box C101 on the web page WP2 as data for choices. Pressing a button B103 of the combo box C101 displays the selections as shown in FIG. 8. Also, mass, part composition ratio, material composition ratio, material name, etc. of each component part are displayed in tables T101 and 102 on the web page WP2. For table T101, because no data are input other than the component part name, the value “N/I” is displayed for the component material name and composition ratio, and contained chemical substance name and content.

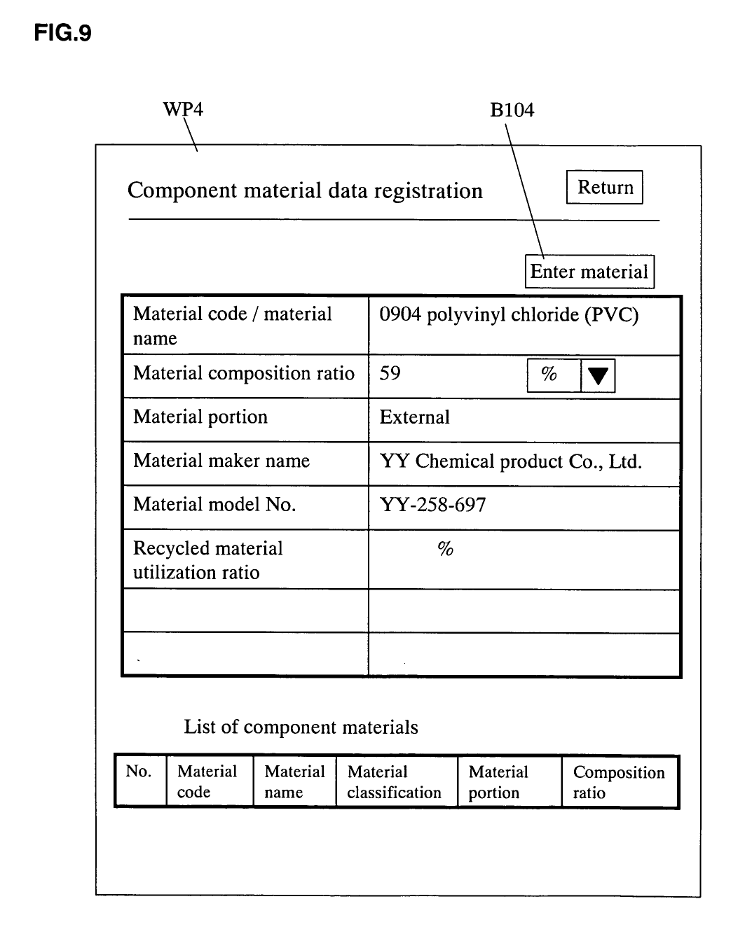

When inputting data of component materials of each component part, a user selects one of component parts in the combo box C101, and then selects a link L102 on the web page WP2. Once the link L102 is selected, the CPU 201 sends a web page WP4 as shown in FIG. 9 to the web client on the terminal 100. On web page WP4, fields are established for inputting material code name/material name, material composition ratio, material portion, material manufacturer name, material model number, etc. When data are input in these fields and a material input button B104 is pressed, input data and a web page send request are sent from the terminal 100 to the server 200. In this example, data of polyvinyl chloride among the materials composing an external tube are input. Inputting and sending data of a component material are repeated for all the materials composing the selected component part.

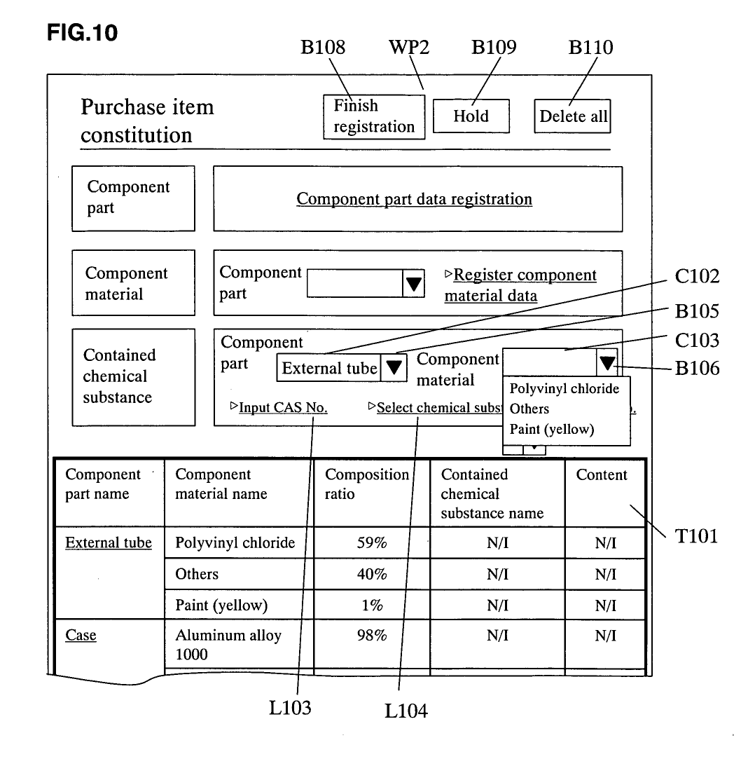

Once data of each component material are received, the CPU 201 sends the web page WP2 to the terminal 100. At this time, the already-input part name of a component part and material name of a component material are established as data for choices in the combo boxes C102 and C103, respectively, on the web page WP2. Pressing a button B105 of the combo box C102 or a button B106 of the combo box C103 displays those choices as shown in FIG. 10. Also, as to the table T101 on the web page WP2, input values of component parts and component material names are displayed, and a value “N/I” is displayed for other contained chemical substance names and contents.

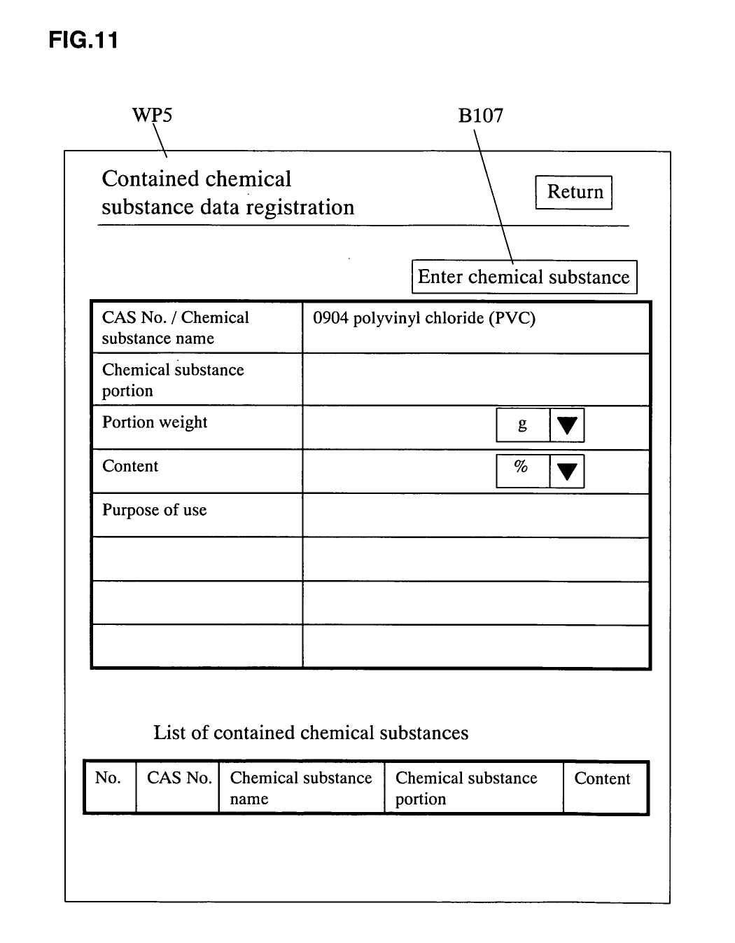

When inputting data of contained chemical substances for each component material, the user selects a component part and a component material in the combo boxes C102 and C103, then selects the link L103 or L104 on the web page WP2. If link L103 is selected, the user can specify a contained chemical substance by inputting the CAS No., and if the link L401 is selected, a contained chemical substance can be input by searching it with its CAS No. or a keyword for the chemical substance name in the chemical substance group. Once a chemical substance name is input and its data are sent to the server 200, the CPU 201 sends a web page WP5 as shown in FIG. 11 to the web client on the terminal 100. Established on this web page WP5 are fields to display already-input CAS No. /chemical substance name, and fields to input the portion of the chemical substance and the weight of the portion, content, etc. Once data are input in the fields and a chemical substance input button B107 is pressed, the input data and a web page send request are sent from the terminal 100 to the server 200. In this example, data of a chemical substance contained in polyvinyl chloride composing an external tube are input. Inputting and sending data of a contained chemical substance are repeated for all the chemical substances contained in the selected material.

When data of each contained chemical substance are received, the CPU 201 sends the web page WP2 to the terminal 100, at which time, in the table T101 on the web page WP2, input values for contained chemical substance names and contents are also displayed.

Once data of a purchased item, component parts of the purchased item, component materials of the parts, and chemical substances contained in the materials are input, a supplier user presses one of buttons B108-B110. If the button B109 is pressed, input data are temporarily held on the server 200. If the button B110 is pressed, input data are deleted. If the button B108 is pressed, a request to register the input data is sent from the terminal 100 to the server 200. Once the server 200 has received the request, immediately or after performing a confirmation process with the user, the CPU 201 registers the input data in the purchased item database 204 established on the HDD 203. Other than the input data, management data such as the date when the data was registered are also recorded in the purchased item database 204. Also, data such as procurement source model number and procurement source mail address input when data of the purchased item were registered are registered to the procurement source database 205 established on the HDD 203 for example.

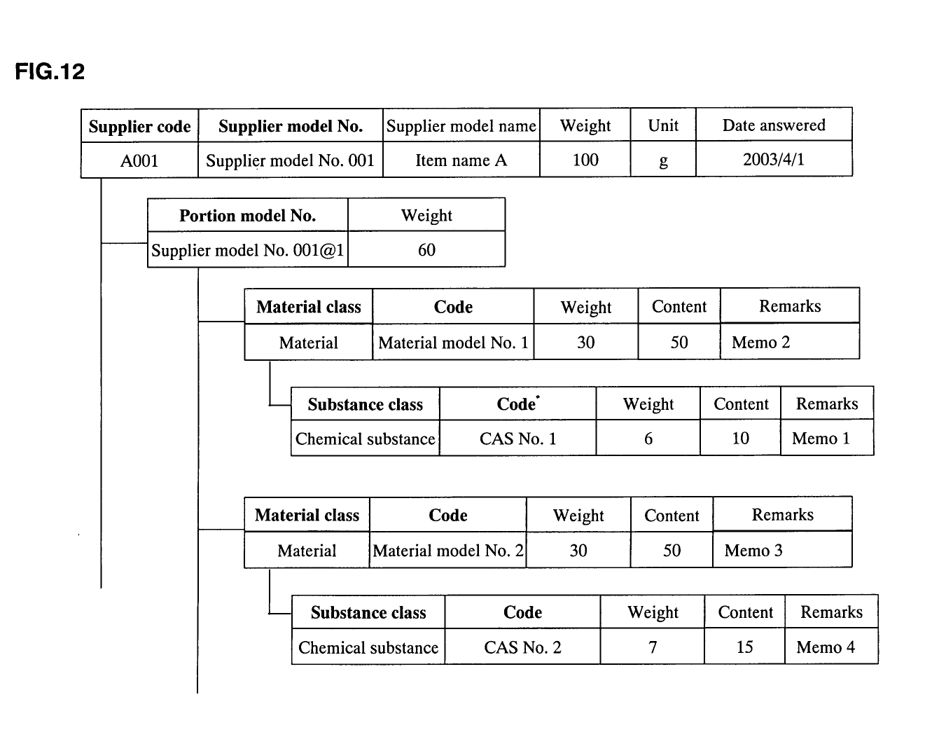

As shown in FIG. 12, the purchased item database 204 manages registered data in a hierarchical relationship of purchased item, component parts of the purchased item, component materials of each part, and chemical substances contained in each material. The hierarchical relationship can be established by preparing a table for each purchased item, component part, component materials, and contained chemical substances, and relating key fields specifying a purchased item, a component part, or a component material among the tables.

The environmental standard database 206 manages environmental standards data for chemical substances by environmental standards such as regulations and manufacturer standards. The environmental standard data include CAS numbers expressing the chemical substance targeted by the restriction, substance names, chemical formulas, and classifications expressing management ranks of the chemical substances, in addition to environmental standard name and classifications expressing the kinds of the environmental standards.

The judging unit 2 judges the state of a purchased item in terms of suitability for environmental standards. Here, the CPU 201 realizes the judging function according to instructions of the procurement data management program.

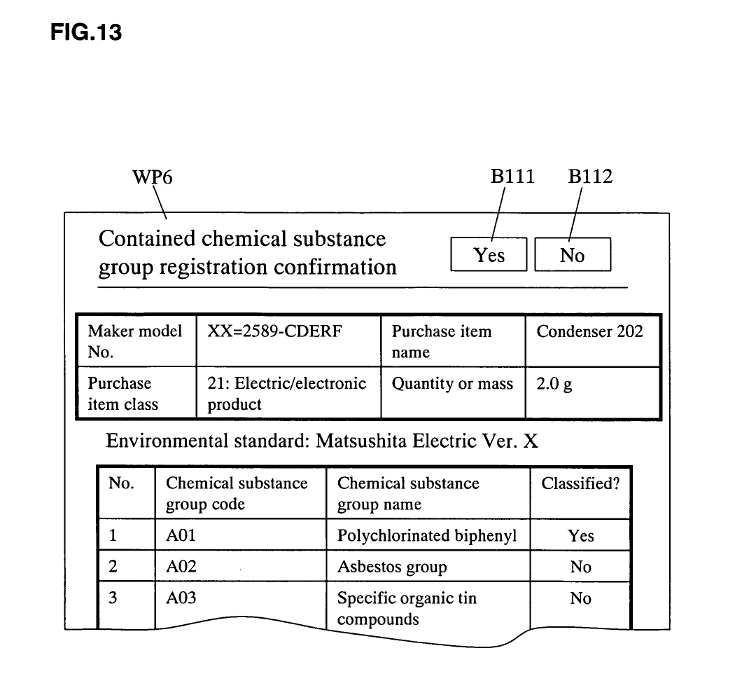

For example, if there is a data registration request on a new purchased item, the CPU 201 refers to the environmental standard database 206 to judge whether any chemical substance regulated by a specified environmental standard is included in the registered chemical substance data. Based on the judgment result, a web page WP6 is created, as shown in FIG. 13. On web page WP6, in addition to a list of whether target purchased items contain any regulated chemical substance, the name of the target purchased item and the manufacturer model number of the purchased item, and the class and quantity or mass of the purchased item are displayed. Also, buttons B111 and B112 are established on the web page WP6 for the user to provide instructions as to whether the registration should be continued or stopped. By the CPU 201 sending the web page WP6 to the web client on the terminal 100, the user is requested to check the registered items.

Also, judgment on the state of suitability for an environmental standard may be made by every component part of the purchased item if the hierarchical relationship between the purchased item and chemical substances is utilized. Judgment by each component part is important in the design stage of a product for example. When making this judgment, a user such as a designer obtains data of a list of parts on the target produce from BOM (Bill Of Materials) and sends data of the list from a terminal 400 to the server 200. Once the server 200 receives the data, the CPU 201 searches the purchased item contained in the list in the purchased item database 204. When a purchased item is searched, the environmental standard database 206 is referred to, and utilizing the hierarchical relationship between the purchased item and contained chemical substances, the state of suitability for a specified environmental standard is judged by each component part. When the judgment is made, the CPU 201 generates data of a list showing the judgment results by each component part of each purchased item used in the target product, and sends the data to a terminal 400. By displaying these data on the terminal 400, the designer can check the state of suitability for the specified environmental standard by each component part of the purchased item. By checking the state of suitability for the environmental standard by each component part of a purchased item, it can be easily judged whether a completely different purchased item needs to be used or only some modification to the specification of the purchased item is necessary. As a result, a product design considering the environment can be efficiently performed.

Note that judgment may be made of whether contents of chemical substances in materials are within appropriate ranges determined by the environmental standard. The judgment may be made using multiple environmental standards for the same purchased item. If an environmental standard is divided into multiple ranks, judgment may be made for each division.

In the above embodiment, data of chemical substances contained in a component material are newly input, already-registered data can be utilized in inputting chemical substances contained in the material. The relationship between a material and chemical substances contained in the material does not usually change even if the parts etc. may be different. If the a material data table and a contained chemical substance data table are already related, with material codes expressing component materials, there is high probability that the contained chemical substances related to that material and chemical substances being input for that material are the same.

Then, when the registration unit 1 inputs material data and then inputs contained chemical substances of that material, if data of the contained chemical substances of that material are already registered before that input of the material data, those registered data may be utilized in inputting the contained chemical substance of that material. For example, once a component material is selected in a combo box C103 on the web page WP2, the CPU 201 searches chemical substances related to that component material in the purchased item database 204. If a chemical substance related to that component material is found, the CPU 201 reads out the value of the chemical substance found, and generates a web page for registering the contained chemical substance data based on that value. By sending this web page, a supplier user can utilize already-registered chemical substance data to input data of the contained chemical substances of the input material. As a result, the supplier users' load can be reduced.

Also, if no data is input on a component part or a component material of a purchased item, the registration unit 1 may register dummy data for the component part or component material.

The composition ratio of a chemical substance is a know-how or a technical secret, practically speaking, and no data registration can be performed on the component material. Also, there may be a case where checking the detailed composition ratio is difficult. If each supplier were always required to register data of any of purchased items, component parts of each purchased item, component materials of each part, and contained chemical substances of each material, such a case would become an obstacle and make data registration hard to perform.

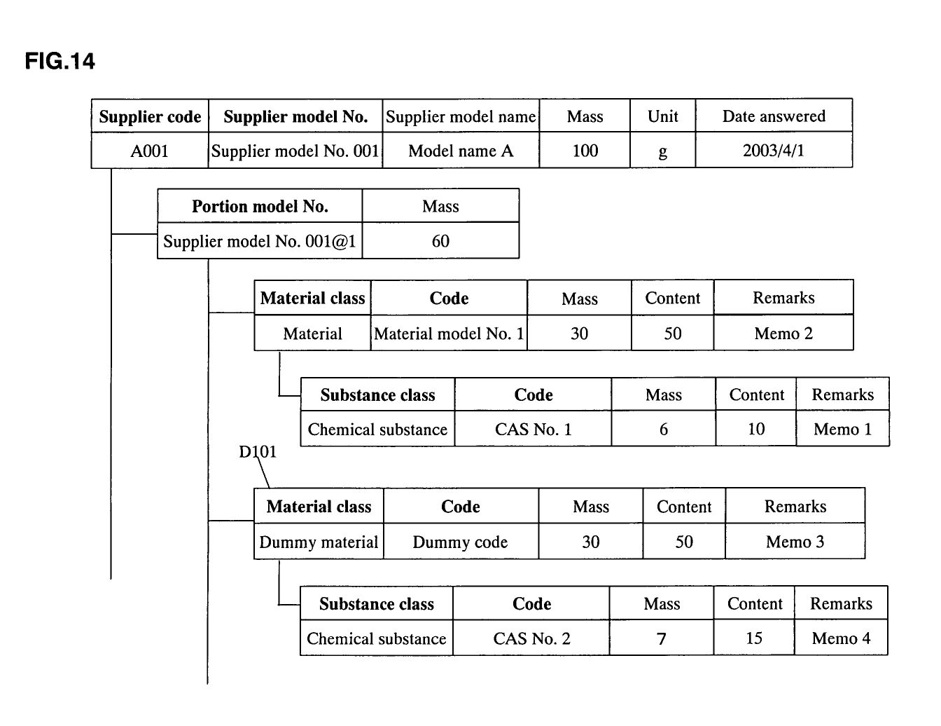

In such a case, registering dummy data makes it easy for a supplier to register data. Even though data are all input for a purchased item, parts of the purchased item, and contained chemical substances, if data of a component material are not input, the CPU 201 automatically registers dummy data D101 for that component material as shown in FIG. 14. Dummy data may be distinguished from data actually expressing the material by giving a specific value to the dummy data or by separately setting up a field indicating that they are dummy data.

While ease of data registration can be thus improved, dummy data should preferably be as small as possible. Because of this, for a purchased item having its material data registered with dummy data, the supplier of the purchased item may be requested to provide material data when necessary.

In this case, the procurement data management system is further equipped with a notification unit 3. When environmental standard data are newly added or modified, if dummy data are registered, the notification unit 3 notifies the supplier of a purchased item corresponding to that dummy data. The notification function can also be realized by the CPU 201 processing according to instructions of a chemical substance management program.

When environmental standard data are newly added or modified, the CPU 201 searches dummy data in the purchased item database 204. When dummy data are found, the CPU 201 specifies the purchased item correspond to the dummy data, and searches for the contact address of the supplier of the purchased item in the procurement source database 205. The mail address is used as the contact address. The CPU 201 creates a mail addressed to that mail address. In the main text of the mail, a request for inputting data of the material is described. Notification is performed by sending the mail. Data of more material can be obtained by such notification.

Notification for dummy data may be periodically performed for example, other than for when a new environmental standard is decided or a modification is made to an environmental standard. When secrecy of a composition ratio becomes unnecessary, or when a detailed composition ratio has been confirmed, if registered data are usually updated voluntarily by a supplier, the need of periodic notification is not high.

Also, judgment in the design stage, explained in the above embodiment, is not a limitation. For example, the judgment result becomes useful even when discarding, recycling, or reusing a marketed product.

A user who performs environmental checks for discarding, recycling, or reusing should specify the target product and send a judgment request form the user's terminal to the server 200. Once the server 200 receives the request, the CPU 201 requests another server to expand the specified target product into its parts. When information on the expanded parts is received from the server, the CPU 201 searches for a purchased item corresponding to that information in the purchased item database 204. Once the corresponding purchased item is found, judgment is made for the purchased item found by each part of the purchased item. By sending the judgment result to the terminal, the user can understand in detail which portion of the target product contains the substance subject to a regulation. If portions containing the substance can be thus removed from the purchased item, it become easier to discard that portion only, recycle the remaining portion, etc.

Because each product to be marketed is usually suitable for the previous regulations and environmental standards, there is little possibility of having a negative influence on the environment or the human body. However, considering the possibility that a new substance becomes regulated or the suitable range of the content becomes narrow after the product is marketed, there is a great importance in making judgment on a product after it is marketed.

Because it is possible that changes are made to the component parts, component materials, and contained substances even if the product or purchased item is the same, it is desirable to relate the date to start its application and the date to end its application, expressing the effective period of the data, with data of each purchased item, component parts of the purchased item, component materials of each part, and contained chemical substances of each material. By utilizing data of the date to start application and the date to end application, appropriate judgment can be made for the same product marketed in different periods.

Furthermore, by not only making a judgment in the design stage or on products purchased by consumers but also targeting products in stock and other products on distribution for judgment, negative influences of products on the environment and human body can be securely suppressed in many processes.

Also, in order to manage progress after a manufacturer requests a supplier to provide it with data of a purchased item until the data are received from the supplier, the procurement data management system may be equipped with a work flow function.

The procurement data management system may further be equipped with an input data checking function. For example, if there is a chemically impossible combination between a material and the contained chemical substance of the material, such knowledge is accumulated in the database in advance, and whether the relationship between each input material and the contained chemical substances is appropriate or not is judged by referring to the database. If it is inappropriate, an error is output, reducing the load of person entering the data.

Also, because quantity or mass of purchased items used in products often vary among products, it is preferred in data management to express material constitution and quantities of contained chemical substances indirectly in terms of material composition ratio and (percent) content.

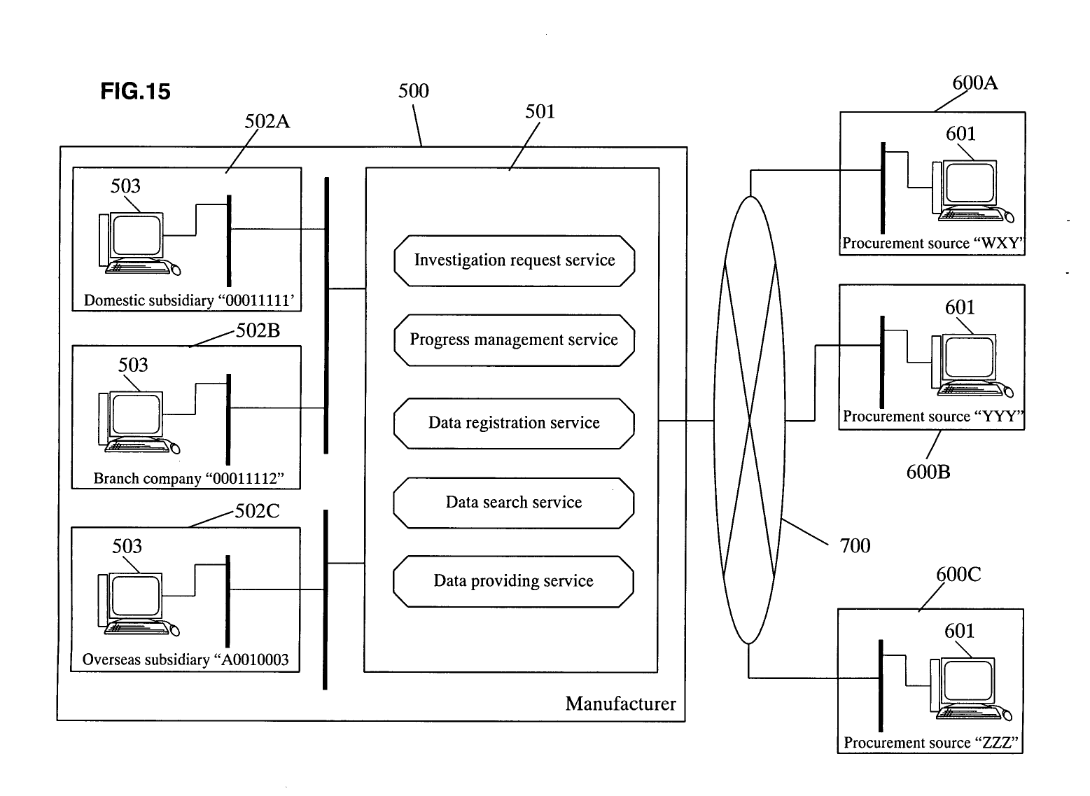

FIG. 15 is a figure for explaining another hardware construction example of the procurement data management system. In this example, a computer 501 used for the procurement data management system is established in a computer system 500 of a manufacturer The computer 501 is connected to computer systems 600A, 600B, and 600C of a plurality of procurement sources via a network 700. Terminals 601 used by each of the procurement source users are established for the systems 600A, 600B, and 600C of procurement sources for purchased items are.

Also, the computer 501 is connected to computer systems 502A, 502B, and 502C of a manufacturer's business establishments. The manufacturer's business establishments include group companies such as subsidiaries, related companies, and overseas subsidiaries, and branch companies. For example, the computer system 502A and 502B are systems of a domestic subsidiary and a branch company, respectively, and the system 502C is a system of an overseas subsidiary. Established for the systems 502A, 502B, and 502C of business establishments are terminals 503 used by users of the business establishment.

In such a constitution, the computer 501 provides users of the manufacturer's business establishments and procurement sources of the manufacturer with the data registration and search services of purchased items. Through that service, users can obtain judgment results on the state of suitability for environmental standards for each part of purchased items used in their products. If there are differences in the environmental standards among countries in which the business establishments are located, the environmental standard database 206 is prepared for each environmental standard. The environmental standards can be switched according to the business establishments by relating the identification codes of the environmental standards with the business establishment codes.

The computer 501 can further provide an investigation request service. Users at each business establishment can utilize that service to request an investigation on a purchased item to its procurement source, and the procurement source can answer to that request to register data of the purchased item. Users may be provided with progress management and other services. In order to perform investigation requests and judgment result notifications, the computer 501 operates according to instructions of the procurement data management program.

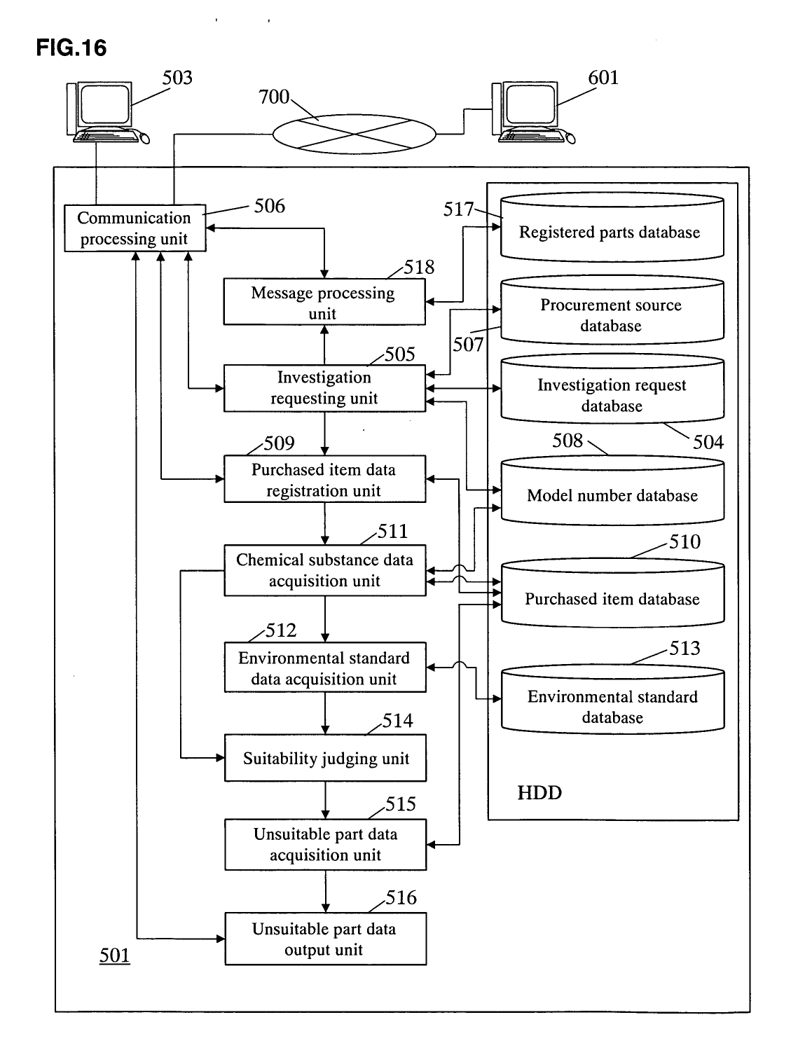

FIG. 16 shows another functional construction example of the procurement data management system. By operating according to instructions of an investigation data management program, the computer 501 can be equipped with an investigation request database 504, an investigation requesting unit 505, a communication processing unit 506, a procurement source database 507, a model number database 508, a purchased item data registration unit 509, a purchased item database 510, a chemical substance data acquisition unit 511, an environmental standard data acquisition unit 512, an environmental standard database 513, a suitability judging unit 514, an unsuitable part data acquisition unit 515, and an unsuitable part data output unit 516. If a purchased item is unsuitable for an environmental standard, other than requesting an investigation to the procurement source, data of parts of the purchased item containing chemical substances not meeting environmental standards are output.

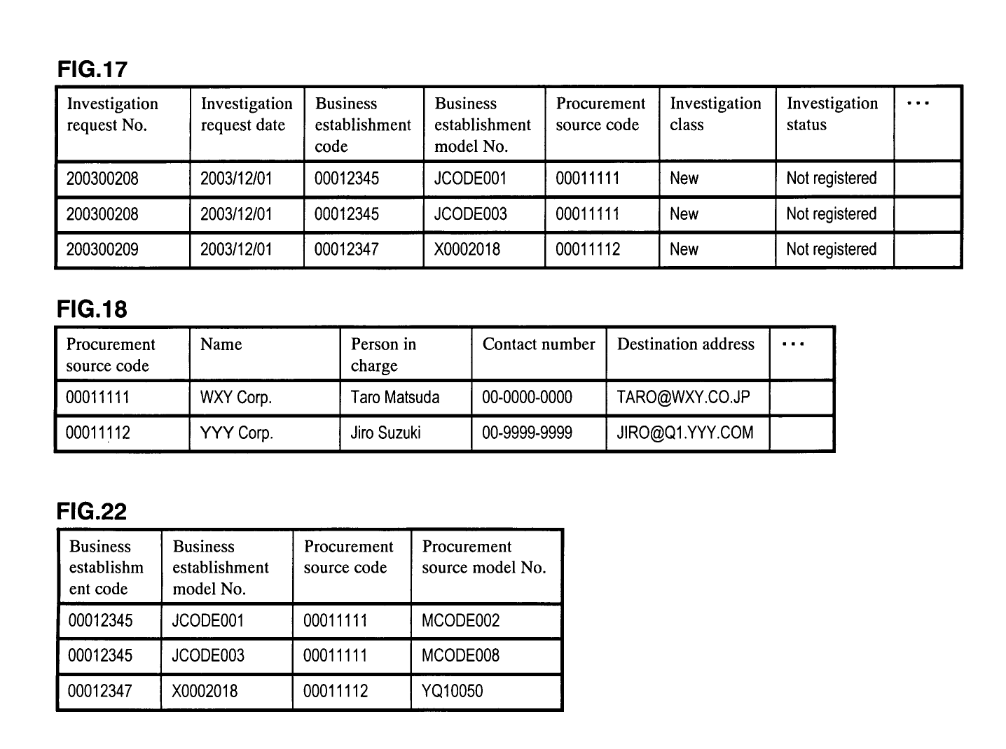

FIG. 17 shows an example of the constitution of the investigation request database. The investigation request database 504 stores data of investigation requests that business establishment users registered. In this example, the investigation request database 504 relates data such as investigation request date, manufacturer business establishment code, business establishment model number, procurement source code, investigation class, and investigation status, to an investigation request number, and stores them. The business establishment model number is a proprietary number given to each purchased item inside the manufacturer's business establishment. Such data are received from the systems 502A-502C and recorded by the computer 501 according to the instruction of a user of each business establishment. One or multiple business establishment model numbers are related to one investigation request number. In this example, two records containing data of “200300208” as the investigation request number are shown. The first record contains “JCODE001” as the business establishment model number, and the second record contains “JCODE003”.

The investigation requesting unit 505 and the communication processing unit 506 send identification code of an investigation request on purchased items used in a product to the procurement source system 600A, 600B, or 600C. The investigation request number of the investigation request database 504 is an example of code identifying an investigation request. The investigation requesting unit 505 sends the investigation request number to the procurement source of a purchased item, by referring to the procurement source database 507 in addition to the investigation request database 504. The procurement source database 507 is basically the same as the procurement source database 205.

FIG. 18 shows an example of the constitution of the procurement source database. The procurement source database 507 relates data such as name of the procurement source, name of the person in charge at the procurement source, contact number of the person in charge, and the destination address for sending an investigation request, to a procurement source code, and stores them. In this example, an e-mail address of the person in charge is stored as the data for the address to send an investigation request.

Here, the computer 501 as the investigation requesting unit 505 generates an investigation request mail writing an investigation request number, and the computer 501 as the communication processing unit 506 sends that mail to a mail address obtained from the procurement source database 507. The computer 501 obtains investigation request data containing an investigation request number and data related to that number from the investigation request database 504. Once the investigation request data are obtained, a procurement source code matching with the procurement source code contained in that data is searched for in the procurement source database 507. If a matching procurement source code is found in the procurement source database 507, the computer 501 extracts data of destination address related to that procurement source code from the procurement source database 507. The computer 501 creates an investigation request mail writing investigation request data in the main text with the extracted mail address as the destination.

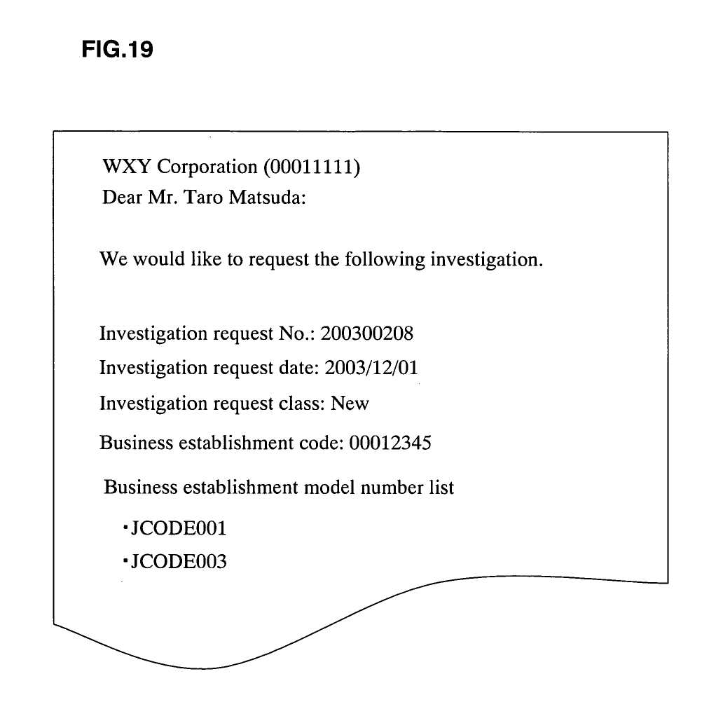

FIG. 19 shows an example of the main text of the investigation request mail. In this example, in addition to an investigation request number and an investigation request date cited, a business establishment code and a business establishment model number list are cited. The investigation request number is “200300208”, and the business establishment model number list contains two business establishment model numbers of “JCODE001” and “JCODE003”. Also, the procurement source code is “00011111”. In the procurement source database shown in FIG. 18, a mail address “taro@wxy.cojp” is related to the procurement source code as the destination address. This mail is sent to a mail server inside the procurement source system 600A for example.

Each user of a procurement source “WXY Corporation” uses a terminal 601 to answer to the investigation request. The computer 501 provides the procurement source user with a web page for the answer. When a web page transfer request is received from the procurement source terminal 601, the computer 501 sends to the terminal 601 a web page for searching investigation requests.

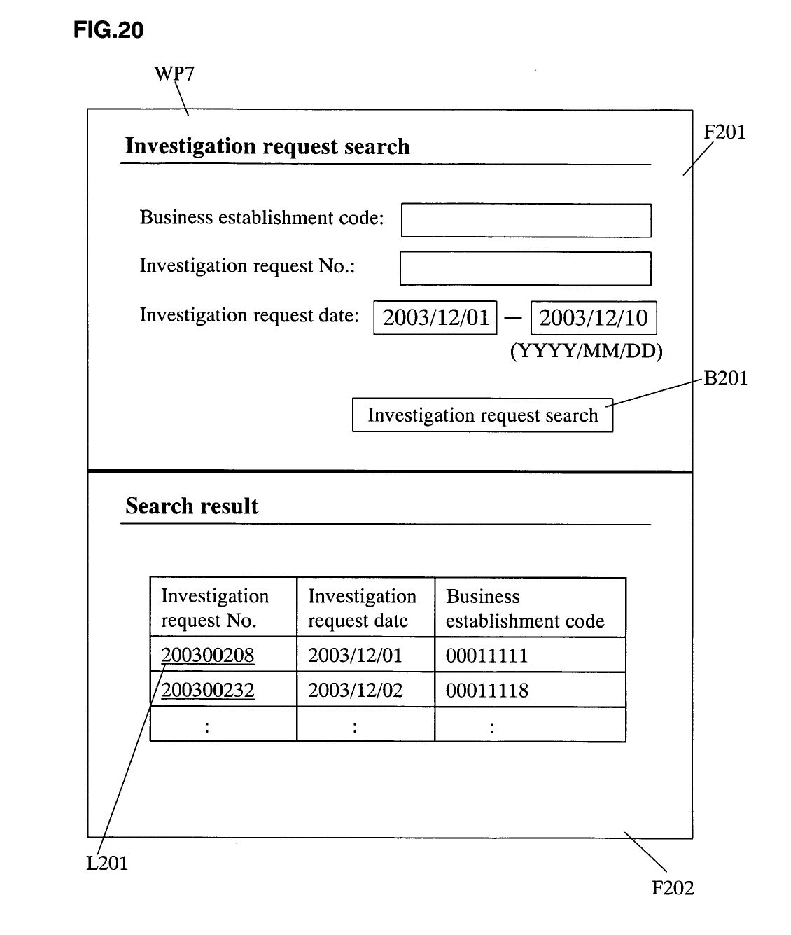

FIG. 20 shows an example of web page for searching for investigation requests. On this web page WP7, a frame F201 for inputting search conditions, and a frame F202 for displaying the search result are arranged. In the frame F201, input fields are prepared for specifying a business establishment code, an investigation request number, and an investigation request date. A procurement source user enters information stated in the investigation request mail in one of the input fields as a search condition, and presses an investigation request search button B201. By this, the terminal 601 sends a search result transfer request to the computer 501. The computer 501 extracts the input search condition data from the transfer request, and searches for the record matching with that data in the investigation request database 504, and further extracts necessary data such as investigation request number, investigation request date, and business establishment code from the record found. Search results are created from the extracted data and sent to the terminal 601 which is the origin of request, and displayed by the frame F202 on the web page WP7. In this example, data of the investigation request number “200300208” are included in the search results. A text showing the investigation request number has a link L201 set up. A link attached to each investigation request number contains the investigation request number itself or data corresponding to it.

When answering to an investigation request, a procurement source user presses a link of the investigation request number corresponding to it. By that operation, the procurement source user can refer to a list of target items of that investigation request. The terminal 601 sends a request to transfer a web page containing the list of target items to the computer 501.

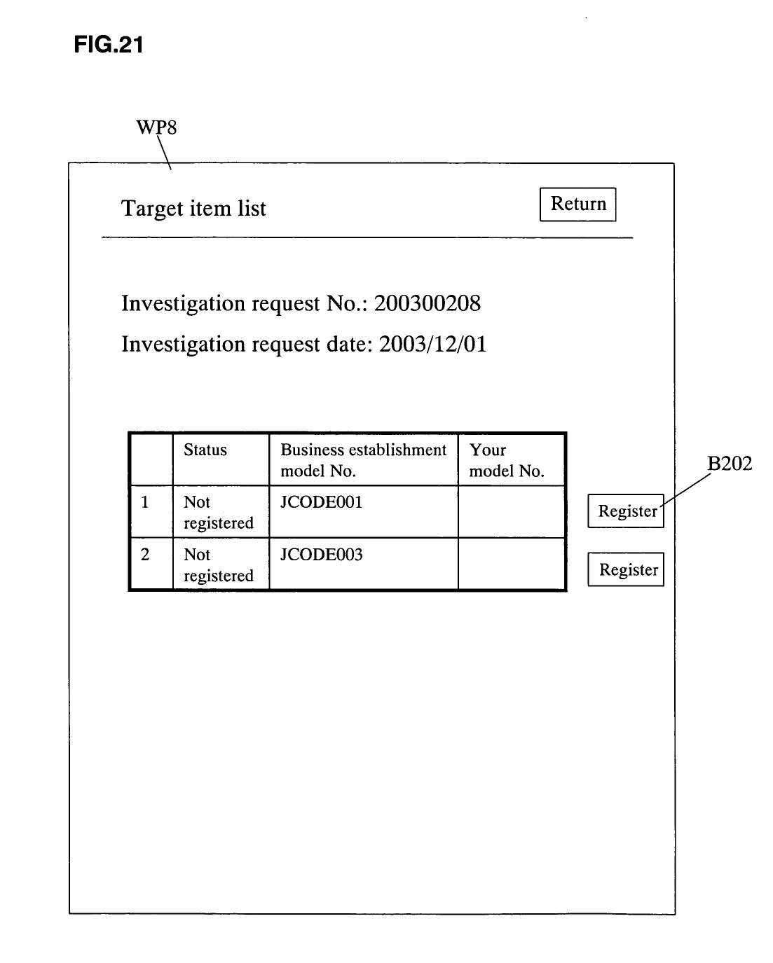

FIG. 21 shows an example of web page containing a list of target items of an investigation request. This web page WP8 shows a list of target items of an investigation request number “200300208”. When the computer 501 receives a transfer request from the terminal 601, it identifies the investigation request number from that request. The computer 501 searches for a record containing the identified investigation request number in the investigation request database 504, and obtains necessary data such as business establishment model number and investigation status from the record found. Using the obtained data, a web page containing a list of target items is created. In this example, the list displays investigation statuses and business establishment model numbers by each target item. Also, each target item has an input field for entering the procurement source model number, and a button B202 for registering purchased item data. When a procurement source user registers data, a procurement source model number is entered in the input field and presses the corresponding button B202, by which the terminal 601 sends to the computer 501 a request to transfer a web page for registering data. The transfer request contains data of investigation request number, business establishment model number, and input procurement source model number for example.

Upon receiving a transfer request, the computer 501 obtains data of investigation request number, business establishment model number, and procurement source model number from the request. The computer 501 searches for a record matching the obtained investigation request number and business establishment model number in the investigation request database 504, and obtains the business establishment code and procurement source code from the record found, and further registers the obtained business establishment code and procurement source code and the received business establishment model number and procurement source model number to the model number database.

FIG. 22 shows an example of the constitution of the model number database. The model number database 508 relates procurement source codes and procurement source model numbers to business establishment codes and business establishment model numbers and stores them. In this example, a procurement source model number “MCODE002” is related to a business establishment model number “JCODE001”.

When an investigation request is made in this way, a part of data input on the web page WP1 for registering data of the purchased item shown in FIG. 3 is already obtained. Therefore, the computer 501 can send to the procurement source terminal 601 the web page WP1 with data prewritten in a part of the input field. Here, in order to obtain quantity and unit of the purchased item, too, a different web page from the web page WP1 is sent to the procurement source terminal 601 as a web page for registering data of the purchased item.

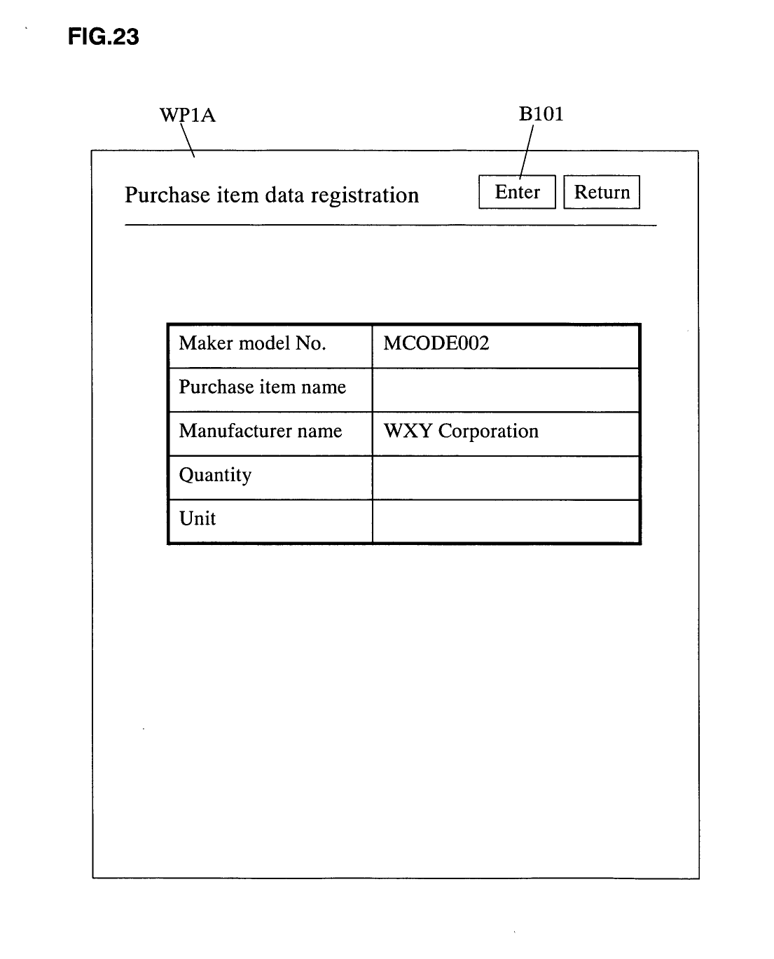

FIG. 23 shows another example of web page for registering data of the purchased item. This web page WP1A has input fields for entering data of procurement source model number, purchased item name, procurement source name, quantity of the purchased item, and unit of quantity. Data of procurement source model number and procurement source name are prewritten by the computer 510 on the web page WP1A. Once a procurement source user enters data in the necessary input fields, he or she presses the button B101 for sending data in the input fields to the computer 501. When the terminal 601 sends data in the input fields, the terminal 601 adds a corresponding investigator request number to the data. The added investigation request number is prewritten by the computer 501 on the web page WP1A.

The purchased item data registration unit 509 receives, together with an investigation request identification code, data of the purchased item containing the proprietary code of the purchased item, data of parts of the purchased item containing the identification codes of the parts, data of materials containing the material codes, and data of chemical substances containing the chemical substance codes from the procurement source terminal. In order to receive such data from the procurement source terminal 601, in addition to the web page WP2 shown in FIGS. 4, 8, and 10, the web pages WP3-WP5 shown in FIGS. 7 and 9-11 are used. The computer 501 buries the procurement source model number as the proprietary code of the purchased item on the web pages WP2-WP5 in addition to the investigation request number, by this, together with the investigation request number, the purchased item data containing the procurement source model number are received from the terminal 601. Also, when the button B102 on the web page WP3 is pressed, according to a script written on web page WP3, the procurement source terminal 601 generates identification codes for parts of the purchased item, for example, by adding an appropriate code to the procurement source model number In addition to data entered on the web page WP3, the computer 501 receives the investigation request number, the procurement source model number, and the identification codes of the parts through the terminal 601. Data entered on the web pages WP4 and WP5 are received as material and chemical substance data. CAS numbers can be used for the chemical substance codes. When a procurement source user presses a button B108 on the web page WP2, the computer 501 registers data received to date to the purchased item database 510.

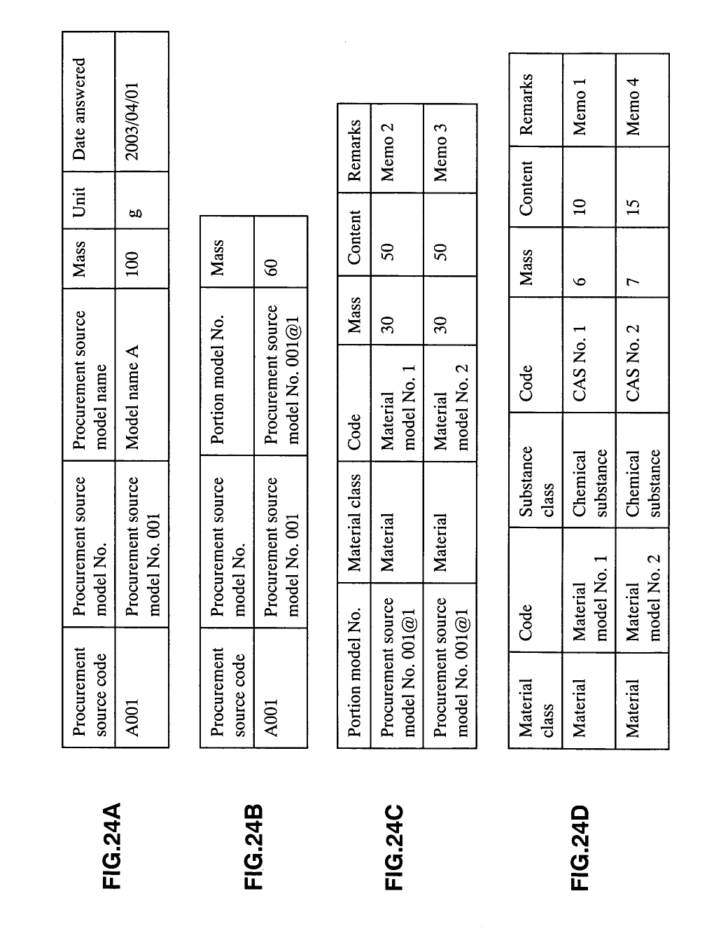

FIG. 24 is a figure for explaining the constitution of the purchased item database. The purchased item database 510 stores data of purchased item, component parts of the purchased item, component materials of each part, and contained chemical substances of each material hierarchically by relating identifications of the parts to the proprietary code of the purchased item, relating material codes to the identification codes of the parts, and relating chemical substance codes to the material codes. The purchased item database 510 has four databases shown in FIGS. 24A-24D. A purchased item main body database in FIG. 24A stores data of each purchased item including the procurement source code and procurement source model number. A purchased item parts database in FIG. 24B relates parts data including the portion model numbers comprising an example of parts identification codes, to the procurement source code and procurement source model number, and stores them. The purchased item material database in FIG. 24C relates material data including the material class and material code to the portion model number, and stores them. A purchased item chemical substance database in FIG. 24D relates chemical substance data including the material class and chemical substance code to the material class and material code, and stores them. The purchased item database 510 is basically the same as the purchased item database 204 shown in FIG. 12.

The chemical substance data acquisition unit 511 extracts data of chemical substances contained in a specified purchased item from the purchased item database by searching for chemical substance codes related to the proprietary code of the purchased item. Specifying a purchased item can be performed by a business establishment user or a procurement source user. The business establishment user can also specify a purchased item by having the computer 501 specify a parts table of a product which is being designed or already designed. For example, the computer 501 extracts procurement source codes and procurement source model numbers from the model number database 508 by obtaining the business establishment model numbers of purchased items contained in a product and searching for a record containing the obtained business establishment model numbers. The computer 501 searches for the portion model numbers related to the extracted procurement source codes and procurement source model numbers in the purchased item database 510, and further searches for the material classes and material codes related to the portion model numbers obtained by the search. The computer 501 extracts the data records of chemical substances including the material classes and material codes obtained by the search in the purchased item database 510. If the extracted chemical substance data records contain multiple records having the same chemical substance code, the computer 501 adds numerical values for the amounts of chemical substances in the records to compute the amount contained in the whole purchased item for each chemical substance. If chemical substance data records corresponding to the portion model numbers obtained by a search contain multiple records having the same chemical substance code, by performing a process to add numerical values for the amounts of chemical substances for each portion model number, the contents of chemical substances can be computed for each part of a purchased item. When computing the contents of chemical substances for each part of a purchased item, by adding the computed values for each chemical substance, the contents for the whole purchased item can be computed for each chemical substance.

The environmental standard data acquisition unit 512 searches for environmental standard data related to a chemical substance code obtained by a search to extract environmental standard data for the extracted chemical substance. The environmental standard database 513 relates environmental standards data for chemical substances, and stores them. The environmental standard database 513 is basically the same as the environmental standard database 206. Each data record of the environmental standard database 513 contains data such as environmental standard name and its class indicating the kind of the environmental standard, CAS number and substance name indicating the chemical substance subject to the regulation, chemical formula, and class indicating the management rank of the substance. The computer 501 searches for records containing the CAS number obtained by a search to obtain the environmental standard data for the extracted chemical substance from the environmental standard database 513. For example, the computer 501 obtains data of the tolerated amount for the extracted chemical substance from the environmental standard database 513.

The suitability judging unit 514 judges whether chemical substances contained in a purchased item are suitable for environmental standards by comparing extracted chemical substance data and environmental standard data for the chemical substances. Here, the content of each chemical substance for the whole purchased item is compared with the tolerated amount. The comparison may be performed for all the chemical substances contained in the purchased item, or only for regulated substances registered in the environmental standard database 512. If no data of a chemical substance contained in a purchased item is registered in the environmental standard database 513, the content of the chemical substance in the purchased item may be compared with the maximum processible value. Also, if data in the environmental standard database 512 indicate that use of a chemical substance is prohibited, the tolerated amount of the chemical substance can be treated as 0. As a result of such comparison, if the contents of all chemical substances in the whole purchased item are below their tolerated amounts, the computer 501 judges that the chemical substances contained in the purchased item are suitable, and otherwise it judges that the chemical substances contained in the purchased item are not suitable.

If there a chemical substance is unsuitable for an environmental standard, the unsuitable part data acquisition unit 515 extracts data of parts containing the chemical substance unsuitable for the environmental standard from the purchased item database 510 by searching for the part identification codes to which the chemical substance code of that chemical substance is related. In the above comparison, if there is a chemical substance unsuitable for an environmental standard, the computer 501 temporarily contains the chemical substance code of the chemical substance in memory. The computer 501 extracts records containing the chemical substance by searching in the purchased item chemical substance database in FIG. 24D. Once records are extracted, material codes are obtained from the record, and records containing the obtained material codes are extracted from the purchased item material database in FIG. 24C. The computer 501 obtains portion model numbers from the extracted records. Once the portion model numbers of parts containing chemical substances unsuitable for an environmental standard are thus obtained from the purchased item database 510, the computer 501 extracts records containing the portion model numbers from the purchased item parts database in FIG. 24B. The computer 501 obtains necessary data from the extracted records. If the purchased item parts database stores data of the names of parts, the data of the portion model number and name are obtained.

The unsuitable part data output unit 516 outputs data of the extracted parts. Data of the extracted parts can be output by the computer 501 sending a list of parts containing chemical substances unsuitable for an environmental standard to the procurement source user. A web page describing the list may be sent to the user's terminal, or mail containing the list may be sent to the user's mail address. For example, the list includes portion model number and name of the part containing chemical substances unsuitable for an environmental standard, and data of the names of chemical substances contained in the part for each part. It may also output a list which includes the portion model numbers and names of parts as the part data for each chemical substance.

In such a procurement data management system, when a chemical substance unsuitable for an environmental standard is contained in a purchased item, its user can immediately understand the parts containing the chemical substance among parts of the purchased item. Once the parts are understood, it becomes easier for the user to decide if the purchased item can be utilized if a small modification is made, if use of the purchased item is difficult, or if the purchased item should be discarded.

In this procurement data management system, the suitability judging unit 514 can also judge whether chemical substances contained in a whole product are suitable for environmental standards instead of judging whether chemical substances contained in a purchased item are suitable for environmental standards. For example, the business establishment model number or procurement source model number of a purchased item used in a product can be obtained from a parts list of the product, the computer 501 can compute the content of each chemical substance of the purchased item as already explained. Therefore, the contents of chemical substances contained in the whole product can be computed by adding the contents of individual purchased items by each chemical substance. The suitability judging unit 514 judges if a product is suitable for environmental standards by comparing the contents computed in this way with the tolerated amounts determined by the environmental standards.

Also, the computer 501 can further be equipped with a registered parts database 517 and a message processing unit 518 by operating according to instructions of the procurement data management program.

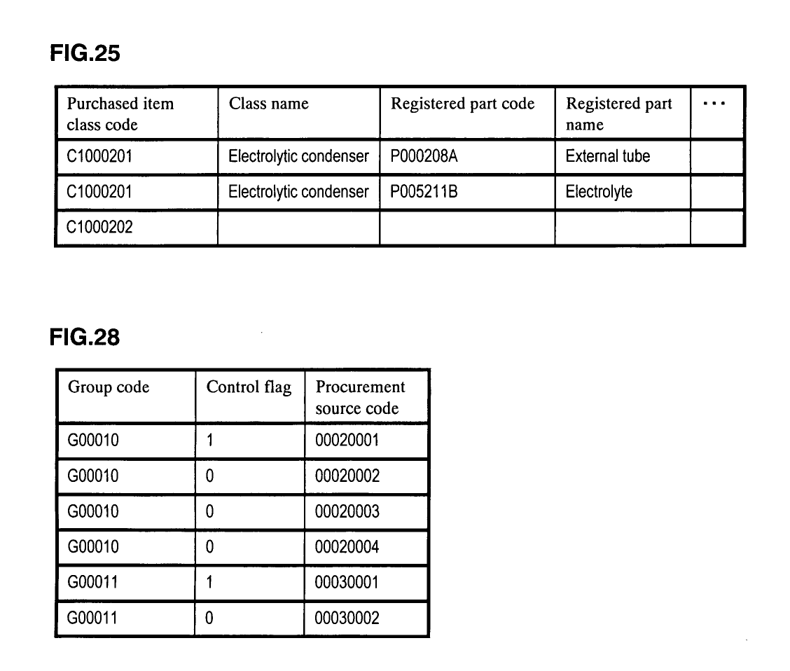

FIG. 25 shows an example of the constitution of the registered parts database 517. The registered parts database 517 relates data of registered parts for a purchased item class to the purchased item class code indicating that class, and stores them. Here, the registered parts database 517 relates data of class name, registered part code, and registered part name to purchased item class codes, and stores them. Registered parts are predetermined by the manufacturers. If there is a part which is commonly contained or usually contained in purchased items belonging to the same class and has a high possibility of containing a regulated substance, that part can be designated a registered part. If there is a registered part in a purchased item class, data of that registered part are stored in the registered parts database 517 in advance. In this example, the registered parts database 517 relates registered part codes “P000208A” and “P005211B” to a purchased item class code “C1000201”, and stores them. Data of registered parts corresponding to the purchased item class code “C1000202” are not stored.

If data of a registered part corresponding to the purchased item class code received from a procurement source terminal, the message processing unit 518 sends a message to the procurement source terminal; for example, a field to select a class of the purchased item established on the web page WP1. The procurement source terminal 601 sends a purchased item class code corresponding to the selection. Once the purchased item class code is received from the procurement source terminal 601, the computer 501 searches for records which contain the purchased item class code in the registered parts database 517. If the found record contains data of the registered parts, a message is sent to the terminals 601 of the procurement sources. For example, this message makes it possible to notify procurement source users, before registering the data of a purchased item, which parts among the parts of the purchased item may contain regulated substances.

Also, the message processing unit 518 may send other messages to the procurement source terminal. For example, if the identification code of a part of a purchased item received from a procurement source terminal is stored in the purchased item database 510, the message processing unit 518 sends a message to the procurement source terminal. Once the identification code of a part of the purchased item is received from the procurement source terminal 601, the computer 501 searches the purchased item database 510. If the purchased item database 510 has a record containing the procurement source code, a message is sent to the terminal 601 of that procurement source. If another business establishment has already requested an investigation concerning the same purchased item, the purchased item database 510 should already be storing data of the purchased item. Therefore, the procurement source does not need to register the purchased item data for that investigation request. By the computer 501 sending a message, the procurement source use can be notified of the fact. When an investigation request is made by a business establishment user, this message may be sent to a terminal 503 of the business establishment user. Once data of investigation request containing a business establishment model number are received from the terminal 503, the computer 501 searches for a procurement source model number corresponding to that business establishment model number in the model number database 508. The computer 501 further searches for records containing the found procurement source model number in the purchased item database 510. If a record obtained by the search contains purchased item data, a message is sent to the business establishment user's terminal 503, by which the business establishment user can know whether the investigation on the target item is complete or not when an investigation request is made, thereby preventing duplicate investigation requests.

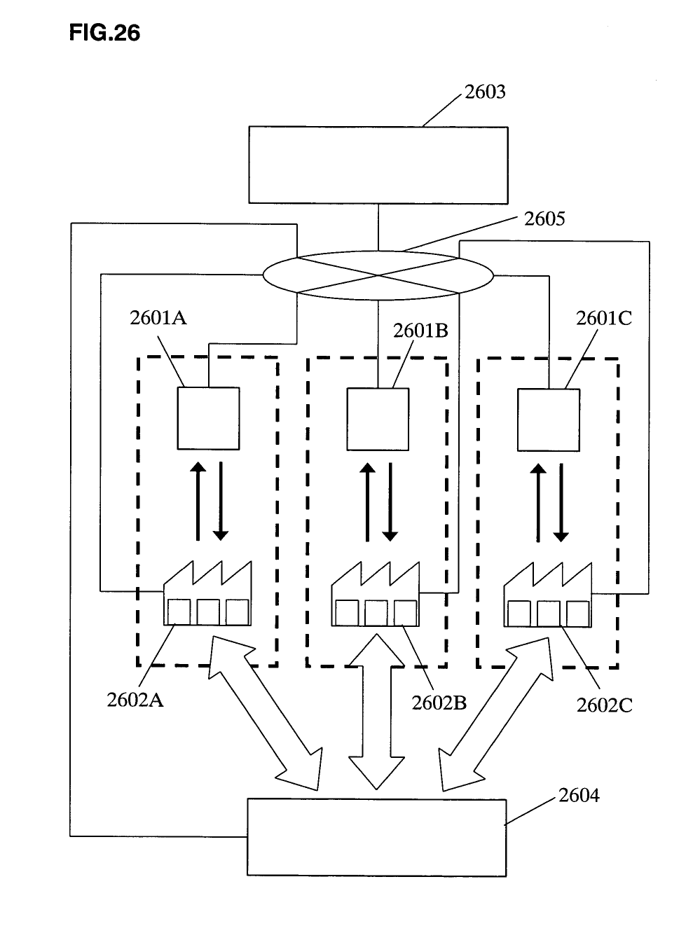

FIG. 26 is a figure which briefly shows a trade relationship among global corporations. If both the supplier of a purchased item used in a product and the manufacturer of the product have global bases, trade between the supplier and the manufacturer can be performed between their bases in each country. For example, the maker's A country branch 2601A purchases parts used in their products from the supplier's A country branch 2602A, and the maker's B country branch 2601B purchases from the supplier's B country branch 2602B. In such a case, bases of manufacturers and suppliers in each country exchange environmental quality data of purchased items, investigation requests on those data, and investigation answers via a computer 2603 used in the procurement data management system.

Many global procurement sources having production and/or sales bases worldwide manage environmental quality data of products in their worldwide factories at their quality control division or production headquarters (hereafter called the centralized management department). Sales and/or production bases in each country do not necessarily manage environmental quality data of their products. Especially, component materials of their products are often provided by other companies, thus grasping their contained chemical substances requires inquiring to the providers or analyzing them. Therefore, it is not rare that each base of a procurement source does not have its own data of component parts, component materials, and/or contained chemical substances of a purchased item.

Here we assume the maker's C country branch 2601C makes an investigation request to the supplier's C country branch 2602C. Because the supplier's C country branch 2602C does not manage environmental quality data, providing the data is requested to the centralized management department 2604. Then, the environmental quality data provided by the centralized management department 2604 are input again by the C country branch 2602C to answer to the investigation.

Such input work is generated at each base of the procurement source. Also, if the environmental quality data are not provided from the centralized management department 2604, each base is unable to respond to the investigation, and the lead time for answering an investigation becomes longer.

The computer 2603 is connected with not only the country bases 2602A-2602C of global procurement sources but also the centralized management department 2604 via a network 2605. The computer 2603 requests the centralized management department to transfer data of purchased items of the country bases 2602A-2602C. The computer 2603 gives permission to the procurement sources belonging to the same group as the centralized management department 2604 for utilizing data supplied from the centralized management department 2604. Permitted country branches 2602A-2602C register their data to the computer 2603 and answer to an investigation, reducing the load at each procurement source base, and shortening the lead time for answering the investigation. Also, the centralized management department 2604 supplies data of the purchased item but does not perform registration. Therefore, the centralized management department 2604 does not need to concretely understand the trades in each country.

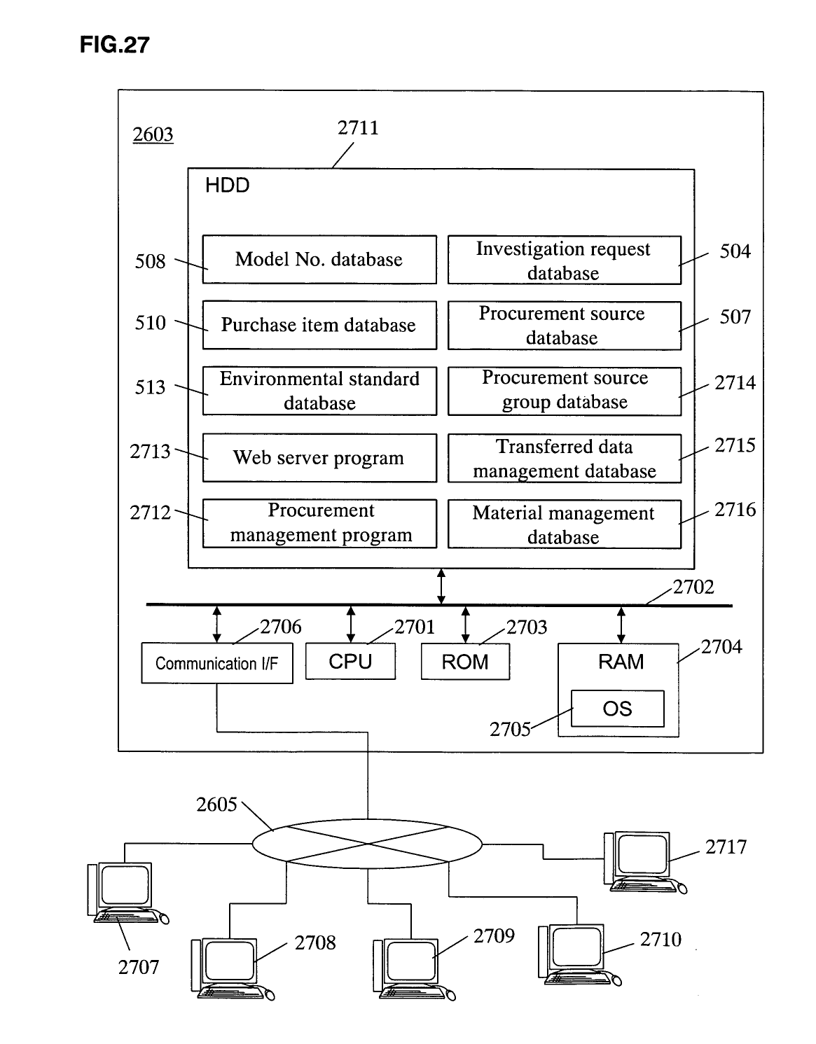

FIG. 27 shows the hardware construction of a computer used in the procurement management system. The computer 2603 is equipped with a CPU 2701 and a bus 2702. The CPU 2701 is connected with ROM 2703 and RAM 2704 via the bus 2702. When the computer 2603 is booted up according to the instruction of a program stored in the ROM 2703, the CPU 2701 operates a part of the whole of an OS 2705 on the RAM 2704.

A communication interface 2706 is also connected to the bus 2702. The communication interface 2706 connects the computer 2603 to a terminal 2707 of a business establishment and terminals 2708-2710 of procurement sources belonging to a procurement source group via the network 2605. The terminal 2708 is a terminal for the centralized management department in the procurement source group. Terminals not belonging to any procurement source group are also connected to the computer 2603 via the communication interface 2706.

An HDD 2711 is also connected to the bus 2702 as a storage device. The HDD 2711 stores files of a procurement management program 2712 executed by the CPU 2701 in order to make the computer 2603 function as a procurement management system. The CPU 2701 reads out files of the procurement management program 2712 from the HDD 2711 to the RAM 2704, and executes codes of the procurement management program 2712. The HDD 2711 stores files of a web server program 2713, other than files of the program 2712.

Also, other than the investigation request database 504, the procurement source database 507, the model number database 508, the purchased item database 510, and the environmental standard database 513, a procurement source group database 2714, a transferred data management database 2715, and a material management database 2716 described later are also constructed on the HDD 2711. The procurement source group database 2714 stores data for managing procurement sources by grouping them. Data related to bases and centralized management department in a global procurement source group are stored in the procurement source group database 2714. The transferred data management database 2715 stores data of purchased items transferred from the centralized management department in the procurement source group.

FIG. 28 shows an example of the constitution of the procurement source group database. The procurement source group database relates a control flag and a procurement source code to a group code, and stores them. The group code is a code uniquely given to each procurement source group which is pre-registered such as global procurement source group. Codes of procurement sources belonging to the same group are related to the same group code.

Each procurement source group registered to the procurement source group database has a centralized management department which manages the environmental quality data. The control flag indicates whether a procurement source belonging to the procurement source group is the management department or not. Here, the control flag is given in a one-bit value. For example, among four procurement sources belonging to a group having a group code “G00010”, the procurement source having a procurement source code “00020001” is the centralized management department, and none of other three procurement sources is a centralized management department.

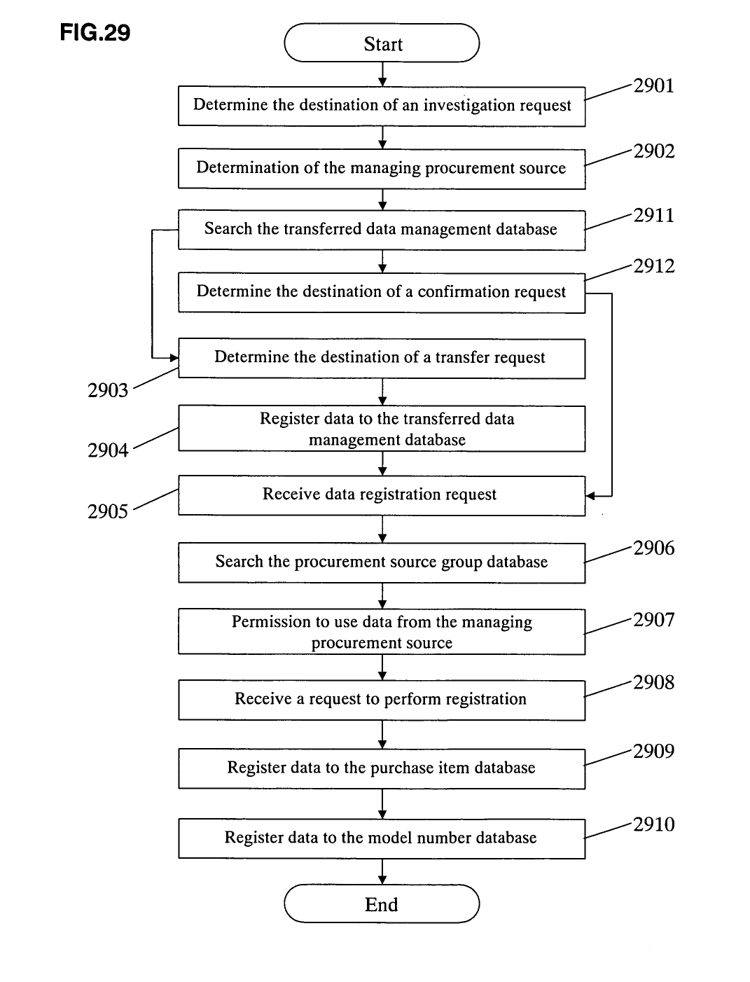

FIG. 29 is a flow chart for explaining an example of procedure for data registration process in the procurement management system. As already described, a computer used in the procurement management system provides each business establishment with a service of requesting investigations on purchased items. When a procurement source is specified by that investigation request, the CPU of the computer determines the destination to send a message requesting registration of data of the purchased items (step 2901). The procurement source database is searched with a specified procurement source code to extract a mail destination address corresponding to that procurement source code from the procurement source database.

Also, the CPU searches the procurement source group database based on the specified procurement source code. If the specified procurement source code is stored in the procurement source group database, a control flag and a group code are read out of the record containing that procurement source code. If it is judged based on the value of that control flag that the procurement source does not manage data of the purchased item, the CPU determines a managing procurement source which manages data of purchased items in the group to which that specified procurement source belongs (step 2902). The CPU searches a record where the control flag has a value of “1” among records of which group code value matches with the value read out, and determines a procurement source specified by the procurement source code contained in that record as the managing procurement source.

The CPU determines managing of the procurement source as the destination of a message requesting a transfer of data of the purchased item (step 2903). The procurement source database is searched based on the procurement source code of the managing procurement source, and a mail address corresponding to that procurement source code is extracted from the procurement source database.

Mail for investigation request or transfer request is sent at any time to the communication interface according to the control of the CPU. When data of the purchased item are received via the communication interface from a terminal of the managing procurement source in response to the transfer request, the computer CPU stores the received data in the HDD (step 2904). In this embodiment, the CPU registers the received data in the transferred data management database. As the transferred data management database, a data constitution similar to the purchased item database shown in FIG. 24 can be adopted. Data related to the purchased item contains data such as procurement source code, procurement source model number, and procurement source model name as the purchased item data. The value of the procurement source code at the centralized management department in that procurement source group will be contained in the procurement source code. Data related to the purchased item contain data of component parts of the purchased item, component materials of each part, and contained chemical substances of each material, other than the purchased item data.

Even if data of the purchased item from the managing procurement source are registered in the transferred data management database, answering the investigation request is not complete. Unless the managing procurement source itself is given the investigation request, the procurement source which received the investigation request should answer to the investigation on the purchased item to complete data registration. A user of the procurement source uses a web page containing a list of target items of the investigation request as shown in FIG. 21 for example in order to request data registration to the procurement management system. By using this web page, a terminal of the procurement source sends a registration request containing the model number at the business establishment which procures purchased item, the model number at that procurement source, and the investigation request number to the procurement management system.

A request to register data of the purchased item is received by the communication interface (step 2905), the CPU searches the procurement source group database based on the code of the requested procurement source (step 2906). If the procurement source code is stored in the procurement source group database, the requesting procurement source is given permission to utilize data of the purchased item from the managing procurement source for registration in response to the investigation request. For example, a web page for searching and copying data registered in the transferred data management database is transferred to the terminal of permitted procurement source in response to its registration request (step 2907). Terminals of non-permitted procurement sources will not be provided with such a user interface. Users of non-permitted procurement sources register data of purchases item by themselves.

A permitted procurement source user can use the web page to search the transferred data management database for data registered by the centralized management department of the group to which the procurement source belongs. A terminal of the permitted procurement source sends the search request to a computer in the procurement source management system. When the search results are received by a terminal of the permitted procurement source, the user selects necessary data for responding to the investigation and instructs performing registration of the selected data. The computer of the procurement source management system receives the registration execution request from a terminal of the permitted procurement source.

When such an execution request is received from a terminal of a permitted procurement source (step 2908), the computer CPU reads out the selected data from the transferred data management database, copies data of the purchased item, and registers it to the purchased item database (step 2909). In the registration, the procurement source code contained in data of the purchased item is changed from a procurement code of the centralized management department to a code of the permitted procurement source.

Also, the CPU specifies, based on data contained in the registration request, the business establishment code procuring the purchased item, the model number of the purchased item at that business establishment, the code of the procurement source, and the model number at the procurement source. Then, the specified data are registered to the model number database as the model number data (step 2910), completing registration of the data of the purchased item.

By the computer CPU executing such a procedure, the investigation load at each procurement source is reduced, and the lead time for answering the investigation is shortened. Also, because the centralized management department provides data of each purchased item but does not perform registration, by which there is no need to concretely understand individual trade between the procurement source and business establishment. In registering data provided from the centralized management department, the procurement source adds information on the business establishment procuring the purchased item.

In the example, as in the step 2903, the managing procurement source has been determined to be the destination of a message requesting transfer of data of the purchased item. However, it is also possible that data of the purchased item are already registered in the transferred data management database by an investigation request from another business establishment.

Therefore, the CPU may execute the step 2903 when data of the purchased item from the managing procurement source are not registered in the transferred data management database. In this case, there is no need to send a transfer request data to the managing procurement source. Hence, an unnecessary transfer request can be suppressed, reducing the load at the centralized management department. The CPU can judge whether data are already registered in the transferred data management database based on the procurement source code of the managing procurement source and the model number of the procurement source.

Furthermore, when the CPU searches data of the purchased item from the managing procurement source in the transferred data management database (step 2911), if the data are already registered, a message requesting a confirmation of the registered data may be sent to the managing procurement source. Even if it may be a purchased item of the same model number, its parts, component materials, and/or contained chemical substance may have changed over time. In this case, the CPU determines the destination of the message requesting the confirmation (step 2912). By the centralized managing department which received this request confirming data in the transferred data management database, the data reliability can be constantly secured. If there is a change in the registered data, the centralized management department transfers the changed data to the procurement management system and registers the data to the transferred data management database.

Also, in sending the transfer request message to a terminal of the managing procurement source via the communication interface, the CPU may execute a procedure to include the code of the procurement source specified in the investigation request in the transfer request message. By including the code of the procurement source specified in the investigation request in the transfer request message, it is possible for the managing procurement source to understand the specified procurement source in addition to information such as the model number of the target item.

Also, once a registration for the investigation request is complete, the CPU may execute a procedure to delete data of the purchased item from the managing procurement source corresponding to that request from the transferred data management database, suppressing the capacity used for the transferred data management database.

Furthermore, the managing procurement source may add to data related to the purchased item the code of procurement source which utilizes the data. The transferred data management database stores not only data related to the purchased item but also the added procurement source code. Once a registration for the investigation request is complete, the CPU can execute a procedure to delete data of the purchased item from the transferred data management database based on the added procurement source code and the code of the procurement source for which the registration was performed. For example, if a procurement source code added, and it coincides with the code of the procurement source which performed the registration, the CPU removes the data of the purchased item from the transferred data management database. Also, if there are multiple procurement source codes added, every time a registration is complete, its procurement source code is removed. If none of the added procurement source codes remain after the removal, the CPU removes data of the purchased item from the transferred data management database. Through such processing, excess data which are not utilized by any other procurement source can be removed from the transferred data management database, enabling suppressing the capacity used for the transferred data management database.

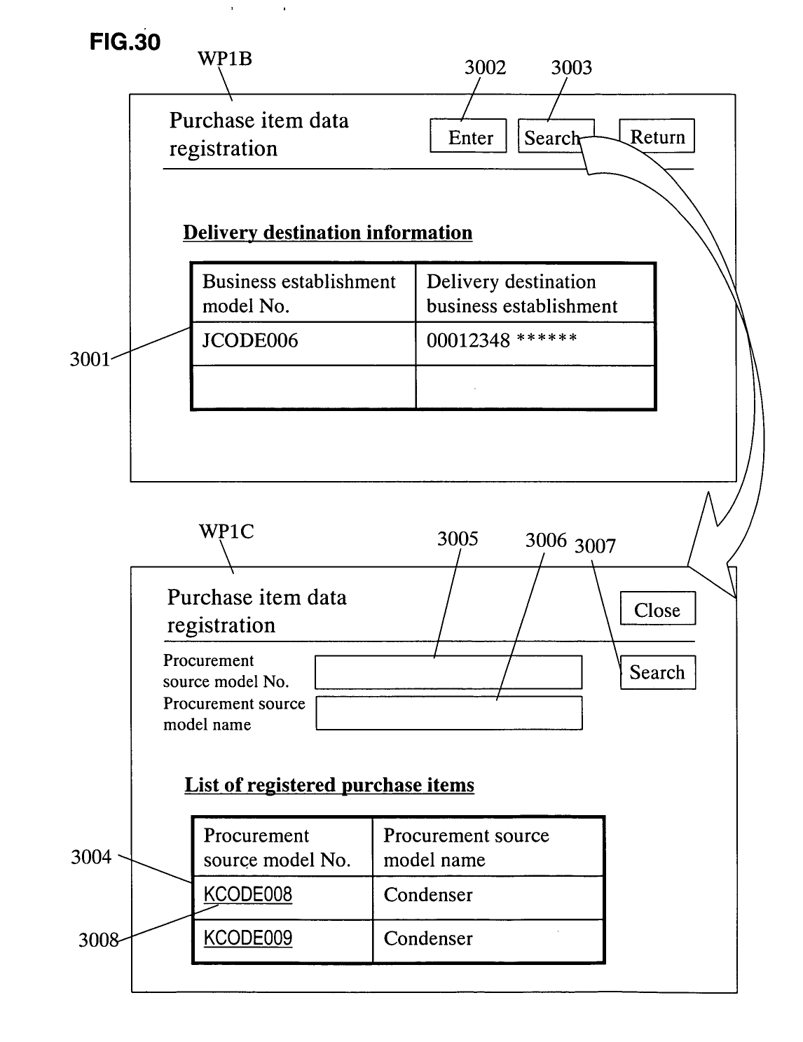

FIG. 30 shows yet another example of web page for registering data of a purchased item. The web page WP1B can e used by permitted procurement sources. The web page WP1B has a specification field 3001 to specify a business establishment model number and a delivery destination business establishment. A user of that procurement source inputs its business establishment model number and delivery destination business establishment in the specification field 3001 before using data registered by the managing procurement source. If data registered by the managing procurement source are not used, an input button 3002 is operated to register data of a purchased item. When using data registered by the managing procurement source, the user operates a search button 3003.

When the search button 3003 is operated, a computer of the procurement management system searches records containing the procurement source code of the managing procurement source in the transferred data management database. The computer creates a web page WP1C displaying the search results and send it to the user's terminal.

This web page WP1C has a display field 3004 which displays the search results. This display field 3004 displays the procurement source model number and procurement source model name of data registered by the managing procurement source. If there are many search results, the user can narrow the conditions in the input fields 3005 and 3006 for procurement source model number and procurement source model name. Once the conditions are narrowed, pressing a search button 3007 can narrow the results displayed on the display field 3004.

On each procurement source model number in the search result, a link 3008 is pasted. When one procurement source model number is operated to select the data, the procurement management system computer reads out and copies the selected data from the transferred data management database, and registers the copied data to the purchased item database.

The user can search only the data registered by the managing procurement source in the procurement group to which the user belongs. Such a restriction may be performed based on the user ID or the procurement source code to which the user belongs.

As shown in FIG. 27, the computer 2603 used for the procurement source management system can be further equipped with a material management database 2716. The material management database 2716 stores data of materials from material providers who provide procurement sources with materials, and contained chemical substances of those materials.

A procurement source having received an investigation request registers, as data of a purchased item, data of the purchased item itself, component parts of the purchased item, component materials of each part, and contained chemical substances of each material. However, it is possible that the procurement source procures the component materials of the purchased item from material providers. In such a case, the procurement source needs to either inquire material providers on data of the materials and/or their contained chemical substances, or analyze the materials on its own. Such inquiry and analysis would increase the load of the procurement source and lengthen the lead time for answering to investigations.

The computer 2603 may be also connected to a terminal 2717 of the material provider via a network 2605. When data of materials and contained chemical substances of each material are received from the material provider's terminal 2717 by the communication interface 2706, the CPU 2701 registers the received data to the material management database 2716.

In registering data of each purchased item, the CPU 2701 searches data of the materials and contained chemical substances of each material in the material management database 2716 based on conditions specified by the procurement source of the purchased item. The procurement source specifies the material manufacturer name, the standard number, the material manufacturer model number, and the trade name, for example, as the search conditions. The CPU 2701 searches the material management database 2716 based on the specified search conditions, and sends the search results to the procurement source terminal.

A user of the procurement source selects materials used in a purchased item and requests registration based on data of the materials to the computer 2603. Once the request is received, the CPU 2701 registers the material used in the purchased item and contained chemical substances of each material to the purchased item database 510 based on the selected materials and contained chemical substances of each material.

By the CPU 2701 executing instructions of the procurement management program 2712, the computer 2603 executes such procedures, freeing the procurement sources from performing inquiry or analysis, reducing the load for answering investigations, and shortening the lead time for answering investigations.

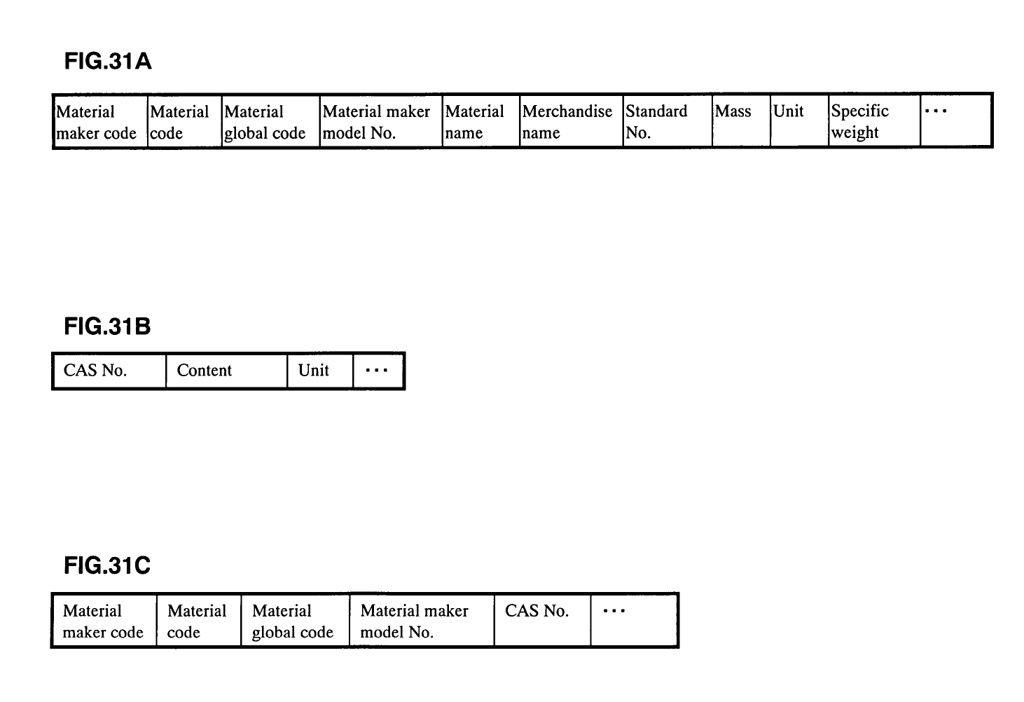

FIG. 31 shows an example of data constitution of the material management database. In the material management database, as shown in FIG. 31A, the material data can contain data such as material manufacturer code, material code, material global code, material manufacturer model number, material name, trade name, standard number, mass, unit, and specific gravity. The material manufacturer code is an identification code for the material provider, the material code is a material code used in the procurement management system, and the material global code is a code added to the material by a department in charge of centralized management of the materials. Also, as shown in FIG. 31B, chemical substance data can contain data such as CAS number, content, and unit. Also, as shown in FIG. 31C, the material management database stores CAS numbers related to material manufacturer codes, material codes, material global codes, and material manufacturer model numbers, and manages data of materials and chemical substances contained in each material.

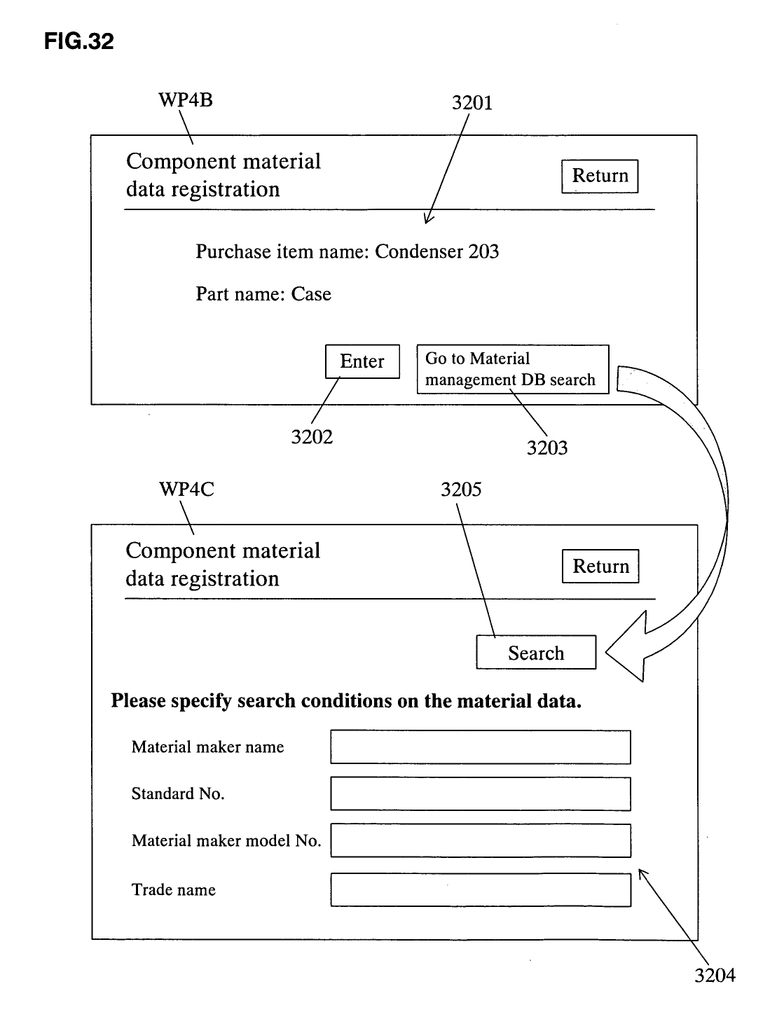

FIG. 32 shows another example of web page for registering data of component materials. A web page WP4B has a display field 3201 for displaying a purchased item and a component part name which becomes the target for entering materials. This field 3201 displays the component part name selected by the user by pressing the link L102 on the web page WP2 shown in FIG. 4 for example. If the user does not use the material management database but enters the material data by himself, he presses a button 3202, by which a transfer request of the web page WP3 shown in FIG. 7 is sent from the user's terminal to the procurement management system computer. When using the material management database, the user presses a button 3203 to send the transfer request of a web page WP4C to the computer.

The web page WP4C is used for search conditions and execution of the search of the material management database. The web page WP4C has input fields 3204 for specifying search conditions and a button 3205 for requesting execution of the search. A user enters a material manufacturer name, a standard number, a material manufacturer model number, and a trade name in the fields 3204, and presses the button 3205 to send the search execution request to the procurement management system. The procurement management system computer searches the material management database based on those conditions and creates a web page displaying the search results. The user of the terminal which received that web page selects a material from the search results and sends a registration request utilizing data of the selected material to the procurement management system. The procurement management system computer reads out data of the selected material and contained chemical substances of the material from the material management database, and creates data used for the registration based on the read-out data and the data format of the purchased item database. The created data are sent to the user's terminal, and after confirmation of the user, are registered to the purchased item database.

The procurement data management program utilized in the above embodiment can be provided to a third party by utilizing an electric communication circuit such as the Internet or storing in a computer-readable recording medium. For example, by expressing program instructions in electric signals, optical signals, or magnetic signals and sending the signal on a carrier wave, the program can be provided through a transmission medium such as coaxial cable, copper wire, and optical fiber. Also, as the computer-readable recording medium, optical media such as CD-ROM and DVD-ROM, magnetic media such as flexible disk, semiconductor memory such as flash memory and RAM can be utilized.

The above embodiment does not limit the technical scope of the present invention, but various kinds of modifications other than those already described are possible within its scope. For example, instead of using a web page for data registration, a file having a form of registration items of data of the purchased item may be exchanged between the procurement management system and the user. In this case, the procurement management system can store that file in a HDD of the computer. The user downloads the file by accessing the procurement management system computer and enters data on that form. The file having a form of registration data in this way may be downloaded by a person other than the procurement source, thereby understanding what kind of items are necessary for data registration. For example, if the procurement source is a trading company, preparing environmental quality data by itself is difficult, and even if the trading company inquires its procurement source, the inquiry items may be difficult to understand clearly in some cases. If a file having a form of registration items is stored in a storage device in a downloadable state, it is possible for the procurement source of the trading company to understand easily the necessary items for data registration.

The procurement data management system of the present invention is efficacious in that environmental management can be efficiently performed in the design stage or recycling of products by judging the state of conformance to environmental standards for each component part of purchased items used in each product, which is useful for designing products, green procurement, and creating discarding guidelines.

What is claimed is:

1. A system for managing data related to purchased items used in products, comprising:
a data processor;
a data storage device; and
a data communication device;
wherein the data storage device has
a purchased item database configured to manage data related to the purchased items in a hierarchical relationship of each purchased item, component parts of each purchased item, component materials of each part, and contained chemical substances of each material,
a list of purchased items used in each product, and
an environmental standard database configured to manage environmental standards data on the chemical substances,
and bears instructions executed by the processor to cause the system perform the steps of:
when the data of the purchased item, and parts, materials, and chemical substances of the purchased item is received by the data communication device from a terminal of the procurement source of the purchased item, registering the received data to the purchased item database;
retrieving the purchased items used in a specified product from the list;
retrieving the data of the chemical substances contained in the retrieved purchased items from the purchased item database;
retrieving the environmental standard data for the retrieved chemical substances from the environmental item database;
judging whether the chemical substances contained in the product are suitable for the environmental standards by comparing the amounts of the chemical substances contained in the product obtained from the retrieved chemical substance data and the tolerated amounts obtained from the environmental standard data for the chemical substances; and
responsive to the chemical substance being unsuitable for the environmental standards, extracting data of parts containing the unsuitable chemical substance among parts of the purchased items used in the product from the purchased item database.

2. The system of claim 1, wherein the data storage device further has a procurement source group database configured to store data of procurement sources and a group to which the procurement sources belong, and data indicating whether the procurement source manages the data related to the purchased items, in the group, and further bears instructions executed by the processor to cause the system perform the steps of:
deciding a specified procurement source should be the destination of a message requesting registration of the data related to the purchased items;
if the specified procurement source is stored in the procurement source group database, searching the procurement source group database to decide a managing procurement source which manages the data related to the purchased items, in the group to which the specified procurement source belongs;
deciding the managing procurement source should be the destination of a message requesting transfer of the data related to the purchased items; and
responsive to the registration of the data related to the purchased items from the requested procurement source, if the requested procurement source is stored in the procurement source group database, granting a permission to the procurement source for utilizing data of the purchased item from the managing procurement source for the registration for the registration request message.

3. The system of claim 2, wherein the data storage device further bears instructions executed by the processor to cause the system perform the steps of:
when data related to the purchased item is received by the data communication device from the managing procurement source terminal, storing the received data related to the purchased item in the data storage device; and
after the registration request for the registration request message is received by the data communication device, from a terminal of the permitted procurement source, reading out and copying from the data related to the purchased item from the managing procurement source the data storage device, and registering the copied data to the purchased item database.

4. The system of claim 3, wherein the data storage device further bears instructions executed by the processor to cause the system perform the steps of
responsive to a registration for the registration request message being complete, deleting data related to the purchased item from the managing procurement source for the registration request message, from the data storage device.

5. The system of claim 3, wherein the data storage device further bears instructions executed by the processor to cause the system perform the steps of
responsive to a registration for the registration request message being complete, deleting data related to the purchased item from the managing procurement source, from the data storage device, based on data added to the data related to the purchased item from the managing procurement source and indicating the procurement source utilizing the data, and the procurement source which performed that registration.

6. The system of claim 2, wherein the data storage device further bears instructions executed by the processor to cause the system to perform the steps of
including data indicating the specified procurement source in the transfer request message when the transfer request message is sent to a terminal of the managing procurement source by the data communication device.

7. The system of claim 1, wherein the data storage device further has a procurement source group database configured to store data indicating whether that procurement source manages data of the procurement source, the group to which that procurement source belongs, and purchased items in that group,
and further bears instructions executed by the processor to cause the system perform the steps of:
deciding a specified procurement source should be the destination of a message requesting registration of data related to the purchased item;
if the specified procurement source is stored in the procurement source group database, searching the procurement source group database to determine a managing procurement source which manages the data related to the purchased items in the group to which the specified procurement source belongs;
deciding the managing procurement source should be the destination of a message requesting transfer of the data related to the purchased item if the data related to the purchased item from the managing procurement source are not stored in the data storage device;
deciding the managing procurement source should be the destination of a message requesting confirmation of stored data if the data related to the purchased item from the managing procurement source are stored in the data storage device; and
responsive to the request to register the data related to the purchased item by the data communication device, if the requested procurement source is stored in the procurement source group database, granting a permission to the procurement source for utilizing the data related to the purchased item from the managing procurement source for a registration for the registration request message.

8. The system of claim 1, wherein the data storage device further has a procurement source group database configured to store data of procurement sources and a group to which the procurement sources belong, and data indicating whether the procurement source manages the data related to the purchased items, in the group, and
a model number database configured to manage model number data indicating the business establishment procuring the purchased item, the model number of the purchased item at that business establishment, the procurement source of the purchased item, and the model number of the purchased item at that procurement source,
and further bears instructions executed by the processor to cause the system perform the steps of:
deciding a specified procurement source should be the destination of a message requesting registration of the data related to the purchased item;
if the specified procurement source is stored in the procurement source group database, searching the procurement source group database to determine a managing procurement source which manages the data related to the purchased items in the group to which the specified procurement source belongs;
deciding the managing procurement source should be the destination of a message requesting transfer of the data related to the purchased item;
when the data related to the purchased item are received by the data communication device from a terminal of the managing procurement source, storing the received data related to the purchased item in the data storage device; and
responsive to the request to register the data related to the purchased item by the data communication device, if the requested procurement source is stored in the procurement source group database, reading out and copying from the data related to the purchased item from the managing procurement source from the data storage device, and registering the copied data to the purchased item database, and registering the model number data containing the business establishment procuring the purchased item, the model number at the business establishment, the requested procurement source, and the model number of the purchased item at the procurement source to the model number database.

9. The system of claim 1, wherein the data storage device further has
a material management database configured to manage data of materials from material providers who provides procurement sources with materials, and chemical substances contained in each material,
and further bears instructions executed by the processor to cause the system perform the steps of:
when data of the material and contained chemical substances of the material are received by the data communication device from a terminal of the material provider, storing the received data in the material management database;
searching for data of the material and contained chemical substances of that material in the material management database based on conditions specified by the procurement source of the purchased item in registering the data related to the purchased item; and
registering data of materials used in parts of the purchased item and chemical substances contained in each material to the purchased item database based on data of the material selected from the found materials and chemical substances contained in the material.

10. The system of claim 1, wherein the data storage device stores a form for registration items of data of the purchased item in a downloadable manner.

11. A method for controlling a system for managing data related to purchased items used in products, the system comprising: a purchased item database configured to manage data related to the purchased items in a hierarchical relationship of purchased items, component parts of each purchased item, component materials of each part, and chemical substances contained in each material; a list of purchased items used in each product; and an environmental standard database configured to manage environmental standards data on the chemical substances, the method comprising the computer-implemented steps of:
when the data of the purchased item, and parts, materials, and chemical substances of the purchased item is received by the data communication device from a terminal of the procurement source of the purchased item, registering the received data to the purchased item database;
retrieving the purchased items used in a specified product from the list;
retrieving the data of the chemical substances contained in the retrieved purchased items from the purchased item database;
retrieving the environmental standards data for the retrieved chemical substances from the environmental standard database;
judging whether the chemical substances contained in the product are suitable for the environmental standards by comparing the amounts of the chemical substances contained in the product obtained from the retrieved chemical substance data and the tolerated amounts obtained from the environmental standard data for the chemical substances; and
responsive to the chemical substance being unsuitable for the environmental standards, extracting data of parts containing the unsuitable chemical substance among parts of the purchased items used in the product from the purchased item database.

12. The method of claim 11, wherein the system further comprises a procurement source group database configured to store data of procurement sources and a group to which the procurement sources belong, and data indicating whether the procurement source manages the data related to the purchased items, in the group, and the method further comprises the computer-implemented steps of:
deciding a specified procurement source should be the destination of a message requesting registration of the data related to the purchased items;
if the specified procurement source is stored in the procurement source group database, searching the procurement source group database to decide a managing procurement source which manages the data related to the purchased items, in the group to which the specified procurement source belongs;
deciding the managing procurement source should be the destination of a message requesting transfer of the data related to the purchased items; and
responsive to the request to register the data related to the purchased item by the data communication device, if the requested procurement source is stored in the procurement source group database, granting a permission to the procurement source for utilizing data on the purchased item from the managing procurement source for the registration for the registration request message.

13. A computer-readable medium bearing instructions for controlling a system configured to manage data related to purchased items used in products, the system comprising: a purchased item database configured to manage data related to the purchased items in a hierarchical relationship of purchased items, component parts of each purchased item, component materials of each part, and chemical substances contained in each material; a list of purchased items used in each product; and an environmental standard database configured to manage environmental standards data on the chemical substances, the computer-readable medium bearing instructions to control the system to perform the computer-implemented steps of:
when the data of the purchased item, and parts, materials, and chemical substances of the purchased item is received by the data communication device from a terminal of the procurement source of the purchased item, registering the received data to the purchased item database;
retrieving the purchased items used in a specified product from the list;
retrieving the data of the chemical substances contained in the retrieved purchased items from the purchased item database;
retrieving the environmental standards data for the retrieved chemical substances from the environmental standard database;
judging whether the chemical substances contained in the product are suitable for the environmental standards by comparing the amounts of the chemical substances contained in the product obtained from the retrieved chemical substance data and the tolerated amounts obtained from the environmental standard data for the chemical substances; and
responsive to the chemical substance being unsuitable for the environmental standards, extracting data of parts containing the unsuitable chemical substance among parts of the purchased items used in the product from the purchased item database.

14. The computer-readable medium of claim 13, wherein the system further comprises a procurement source group database configured to store data of procurement sources and a group to which the procurement sources belong, and data indicating whether the procurement source manages data related to the purchased items, in the group, and the computer-readable medium further bears instructions to control the system to perform the computer-implemented steps of:
deciding a specified procurement source should be the destination of a message requesting registration of the data related to the purchased item;
if the specified procurement source is stored in the procurement source group database, searching the procurement source group database to decide a managing procurement source which manages the data related to the purchased items, in the group to which the specified procurement source belongs;
deciding the managing procurement source should be the destination of a message requesting transfer of the data related to the purchased items; and
responsive to the request to register the data related to the purchased item by the data communication device, if the requested procurement source is stored in the procurement source group database, granting a permission to the procurement source for utilizing data of the purchased item from the managing procurement source for the registration for the registration request message.

15. A procurement data management system utilizing a computer connected via a network to terminals of procurement sources of purchased items used in products, the system comprising:
a unit configured to receive data of the purchased items containing proprietary codes of the purchased items, data of parts containing identification codes of the parts of each purchased item, data of materials containing material codes, and data of chemical substances containing chemical substance codes from procurement source terminals;
a purchased item main body database configured to store the data of the purchased items used in the products;
a purchased item parts database configured to store the data of the component parts of each purchased item used in each product, the data of the component part being associated with the proprietary code of the purchased item;
a purchased item material database configured to store the data of the component materials of each part, the data of the component materials being associated with the identification code of the part;
a purchased item chemical substance database configured to store the data of the chemical substances contained in each material, the data of the chemical substances being associated with the material code;
a list of purchased items used in each product;
an environmental standard database configured to store environmental standards data on the chemical substances, the environmental standards data being associated with the chemical substance codes;
a unit configured to extract the data of the chemical substances contained in a specified product by searching the purchased item parts database for data of component parts associated with the proprietary codes of purchased items used in the product, searching the purchased item material database for data of component materials associated with the identification data of parts contained in the component parts data found, and searching the purchased item chemical substance database for data of contained chemical substances associated with the material codes contained in the component material data found;
a unit configured to retrieve the environmental standard data for the extracted chemical substances from the environmental standard database by searching the environmental standard data associated with the chemical substance codes obtained by the search;
a suitability judging unit configured to judge whether the chemical substances contained in the product are suitable for the environmental standards by comparing the contents of the chemical substances in the product obtained from the extracted chemical substance data and the tolerated amounts for the chemical substances obtained from environmental standard data;
a unit, responsive to the chemical substance being unsuitable for environmental standards, configured to search the purchased item chemical substance database for material codes with which the chemical substance code of the chemical substance is associated, search the purchased item material database for the identification codes of parts with which the found material codes is associated, and extract data of parts containing chemical substance unsuitable for the environmental standards based on the identification codes found; and
a unit configured to output data of the extracted parts.

16. The procurement data management system of claim 15, further comprising:
a registered parts database configured to store data of registered parts for classes of the purchased items, associated with purchased item class codes indicating the classes of the purchased items; and
a unit, if the data of the registered parts corresponding to the purchased item class codes received from the procurement source terminal is stored in the registered parts database, configured to send a message to the procurement source terminal.

17. The procurement data management system of claim 15, further comprising:
a unit, if the identification codes of the parts of the purchased items received by the procurement destination terminal are stored in the purchased item database, configured to send a message to the procurement source terminal.
